(19) United States
(12) Patent Application Publication
(10) Pub. No.: US 2026/0202065 A1
(43) Pub. Date: Jul. 16, 2026

(54) COOKING APPLIANCE

(71) Applicant: LG ELECTRONICS INC., Seoul (KR)

(72) Inventors: Wontae KIM, Seoul (KR); Haemin KIM, Seoul (KR); Jaeho LEE, Seoul (KR); Seongsoon AHN, Seoul (KR)

(21) Appl. No.: 19/135,839

(22) PCT Filed: Dec. 6, 2023
(86) PCT No.: PCT/KR2023/020028

§ 371 Date: Jun. 5, 2025

(30) Foreign Application Priority Data
Dec. 6, 2022 (KR) 10-2022-0168535

(51) Int. Cl. F24C 15/20; H05B 6/64

(52) U.S. Cl. CPC F24C 15/20; H05B 6/64

(57) ABSTRACT

An invention related to a cooking appliance is disclosed. In the disclosed invention, a fan assembly for suctioning air into the cooking appliance, and then exhausting same to the outside of the cooking appliance is disposed in the cooking appliance, the fan assembly being disposed in the space between the back surface of a cavity in which a cooking chamber is formed, and a rear plate which forms the rear exterior of the cooking appliance.

### TECHNICAL FIELD

The present disclosure relates to a cooking appliance, and more particularly, to a cooking appliance which provides both a cooking function and a hood function.

### BACKGROUND ART

A cooking appliance is a home appliance for cooking food, and is an apparatus installed in a kitchen space to cook food according to a user's intention. Such cooking appliances may be variously classified according to a heat source, a form, or a type of fuel to be used.

When the cooking appliances are classified according to the type of food being cooked, the cooking appliances may be classified into open type and closed type cooking appliances according to a type of space in which the food is placed. The closed type cooking appliance includes an oven, a microwave oven, etc. and the open type cooking appliance includes a cooktop, a hop, etc.

The closed type cooking appliance is a cooking appliance that encloses a space in which food is located and heats the enclosed space to cook food. In the closed type cooking appliance, a chamber, that is, a cooking chamber, which is a space that is enclosed when food is to be cooked while the food is placed, is provided inside the main body. Such a cooking chamber becomes a space in which food is substantially cooked. A heat source is provided in the inner or outer space of the cooking chamber to heat the cooking chamber.

The microwave of the closed type cooking appliance is a cooking apparatus which generates microwaves using electricity to extend through into an object to be cooked accommodated in a cooking chamber, thereby heating the object to be cooked by causing molecular movement therein.

A microwave oven is a kitchen appliance which simultaneously heats the inside and the outside of the food by irradiating the high frequency wave from the magnetron to the food, and is widely used due to advantages such as significantly shortening the cooking time of the food due to high thermal efficiency, reducing the loss of nutritional value during cooking, defrosting, and heating of the food, and enabling direct cooking while the food is stored in a container.

Recently, a microwave oven combined with a hood function also known as an OTR (Over the Range) type microwave oven has been released. The OTR type microwave oven having the hood has a hood function of discharging air (hereinafter referred to as “cooking gas”) containing foreign substances generated in the process of cooking food from a cooking appliance installed thereunder, or filtering the cooking gas and then discharging the filtered gas to the inside.

A fan for suctioning and discharging air is provided in the hood-combined microwave oven. Such a fan is typically disposed on top of the cavity defining the cooking chamber therein. That is, in the microwave oven having the hood, the fan is generally disposed on top of the cavity.

However, when the fan is disposed at the position as described above, a distance between the fan and a suction hole disposed at a lower end of the hood-combined microwave oven is greater than a vertical length of the cavity. As described above, the distance between the suction hole and the fan is increased, such that the cooking gas collection performance of the microwave oven having the hood is inevitably lowered. This is because a flow rate of the suctioned airflow generated by the fan may be lowered in a manner inversely proportional to a square of the distance from the fan to the suction hole.

In addition, when the fan is disposed at the above-described position, an entirety of the vertical length of the hood-combined microwave oven is inevitably increased. Thus, when the hood-combined microwave oven having the increased vertical length is installed in an upper cabinet, the possibility that the hood-combined microwave oven protrudes downwardly beyond the upper cabinet is increased.

When the microwave oven having the hood protrudes downwardly beyond the upper cabinet, aesthetics thereof is not good, and a problem in which a spacing between a cooktop installed under the upper cabinet and the microwave oven having the hood is smaller may occur.

When the spacing between the cooktop and the microwave oven having the hood is smaller as the microwave oven having the hood protrudes downwardly beyond the upper cabinet, a problem in which the microwave oven having the hood screens the field of view of the user who wants to use the cooktop and a problem in which a cooking area of the cooktop is smaller may occur.

### SUMMARY OF DISCLOSURE

### Technical Purpose

A purpose of the present disclosure is to provide a cooking appliance with an improved structure to provide a hood function while suppressing an increase in a total vertical length of the cooking appliance.

In addition, another purpose of the present disclosure is to provide a cooking appliance having an improved structure so as to reduce a flow loss generated inside the cooking appliance while suppressing an increase in a total volume of the cooking appliance.

In addition, still another purpose of the present disclosure is to provide a cooking appliance having an improved structure so that the structure may be simplified and the number of steps of an assembly process thereof may be efficiently reduced.

### Technical Solution

The cooking appliance for achieving the above purpose according to an embodiment of the present disclosure is characterized in that a fan assembly for suctioning air into the inside of the cooking appliance and then discharging the air to the outside out of the cooking appliance is disposed in rear of a cavity having a cooking chamber defined therein.

In addition, a cooking appliance of another aspect of the present disclosure is characterized in that a fan assembly for suctioning air into the inside of the cooking appliance and then discharging the air to the outside out of the cooking appliance is disposed inside the cooking appliance, and is disposed in a space defined in rear of the cavity.

In addition, a cooking appliance of according to still another aspect of the present disclosure is characterized in that a fan assembly for suctioning air into the inside of the cooking appliance and discharging the air to the outside out of the cooking appliance is disposed inside the cooking appliance, and is disposed in a space between a rear surface of a cavity having a cooking chamber defined therein and a rear plate constituting an outer appearance of a rear surface of the cooking appliance.

A cooking appliance according to one aspect of the present disclosure may include: a main body including a cavity having a cooking chamber defined therein; and a blower disposed inside the main body.

In addition, the main body may include an air intake hole disposed below the blower, and an exhaust hole disposed above the air intake hole.

In addition, the blower may include a fan assembly disposed in a space communicating with the air intake hole and the exhaust hole.

In addition, the fan assembly may include a fan housing in which a suction hole and a discharge hole are defined, and an impeller accommodated in the fan housing and configured to suction the air through the suction hole and discharge the suctioned air through the discharge hole.

In addition, the impeller may be configured to rotate about a vertical axis and suction air in the vertical direction.

In addition, the fan assembly may be disposed in rear of the cavity, and be configured to suction air through the air intake hole, and discharge the suctioned air to the exhaust hole.

Moreover, the main body may further include a rear plate disposed in rear of the cavity.

Furthermore, the fan assembly may be disposed in a rear space defined between the cavity and the rear plate.

In addition, the main body may further include a cabinet having an upper surface disposed above the cavity.

Moreover, the exhaust hole may communicate with an upper space defined between the upper surface of the cavity and the upper surface of the cabinet.

In addition, the fan assembly may be configured to discharge the suctioned air to the upper space.

In addition, the exhaust hole may be formed to extend through the upper surface of the cabinet.

In addition, the discharge hole may be disposed to face in a lateral direction and to face a lateral center of the cooking appliance.

In addition, the suction hole may be disposed to face toward the air intake hole.

In addition, the cooking appliance may include a plurality of fan assemblies which are arranged in a lateral direction.

In addition, the fan assembly may include a pair of fan assemblies arranged symmetrically with each other, and the discharge hole defined in one of the pair of fan assemblies may be disposed to face the discharge hole defined in the other of the pair of fan assemblies.

Furthermore, the blower may further include a second fan assembly configured to suction the air in a lateral direction and discharge the suctioned air upwardly.

In addition, the fan assembly and the second fan assembly may be laterally arranged and be disposed in rear of the cavity.

In addition, in the vertical direction, the second fan assembly may be disposed at a position closer to the air intake hole than to the exhaust hole.

In addition, in the vertical direction, at least one of the fan assembly and the second fan assembly may be disposed between the upper surface and the lower surface of the cavity.

### Technical Effect

In the cooking appliance of the present disclosure, a blower for providing the hood function is disposed in rear of the cavity, thereby providing the hood function while suppressing an increase in the vertical length of the cooking appliance.

In addition, in the cooking appliance of the present disclosure, the blower may be disposed in the rear space instead of the side space and the upper space inside the main body, thereby effectively suppressing an increase in each of the vertical and lateral lengths of the cooking appliance and providing the hood function with improved performance at the same time.

In addition, the cooking appliance of the present disclosure employs a structure in which the blower is disposed in the rear space connected in a straight line to the exhaust hole, thereby minimizing flow loss inside a cooking appliance, thereby providing further improved cooking gas removal performance.

In addition, the cooking appliance of the present disclosure may provide the improved cooking gas removal performance while being smaller in size compared to a cooking appliance including a blower of a type different from the blower of the above type.

### BRIEF DESCRIPTION OF DRAWINGS

FIG. 1 is a perspective view illustrating a cooking appliance according to a first embodiment of the present disclosure.

FIG. 2 is a perspective view showing an internal structure of the cooking appliance shown in FIG. 1 in a see-through state.

FIG. 3 is a front view illustrating an internal structure of the cooking appliance illustrated in FIG. 1.

FIG. 4 is a plan view showing an internal structure of the cooking appliance shown in FIG. 1.

FIG. 5 is a side view illustrating an internal structure of the cooking appliance illustrated in FIG. 1.

FIG. 6 is a rear perspective view illustrating an internal structure of the cooking appliance illustrated in FIG. 1.

FIG. 7 is a plan view illustrating a fan assembly as separated from the cooling appliance as illustrated in FIG. 6.

FIG. 8 is a diagram showing a state in which cooking gas is discharged into an outdoor space in the cooking appliance according to the first embodiment of the present disclosure.

FIG. 9 and FIG. 10 are diagrams showing a state in which cooking gas is discharged into an indoor space in the cooking appliance according to the first embodiment of the present disclosure.

FIG. 11 is a perspective view illustrating an internal structure of a cooking appliance according to a second embodiment of the present disclosure in a see-through state.

FIG. 12 is a front view illustrating an internal structure of the cooking appliance illustrated in FIG. 11.

FIG. 13 is a plan view showing an internal structure of the cooking appliance shown in FIG. 11.

FIG. 14 is a side view illustrating an internal structure of the cooking appliance illustrated in FIG. 11.

FIG. 15 is a rear perspective view illustrating an internal structure of the cooking appliance illustrated in FIG. 11.

FIG. 16 is a plan view illustrating a fan assembly as separated from the cooling appliance as illustrated in FIG. 11.

FIGS. 17 and 18 are diagrams illustrating a state in which cooking gas is discharged into an outdoor space in the cooking appliance according to the second embodiment of the present disclosure.

FIG. 19 is a diagram showing a state in which cooking gas is discharged into an indoor space in the cooking appliance according to the second embodiment of the present disclosure.

FIG. 20 is a perspective view illustrating an internal structure of a cooking appliance according to a third embodiment of the present disclosure in a see-through state.

FIG. 21 is a front view illustrating an internal structure of the cooking appliance illustrated in FIG. 20.

FIG. 22 is a plan view showing an internal structure of the cooking appliance shown in FIG. 20.

FIG. 23 is a side view illustrating an internal structure of the cooking appliance illustrated in FIG. 20.

FIG. 24 is a rear perspective view illustrating an internal structure of the cooking appliance illustrated in FIG. 20.

FIG. 25 is a side view illustrating a third fan assembly separated from the cooling appliance illustrated in FIG. 20.

FIGS. 26 and 27 are diagrams illustrating a state in which cooking gas is discharged into an outdoor space in the cooking appliance according to the third embodiment of the present disclosure.

FIG. 28 is a diagram showing a state in which cooking gas is discharged into an indoor space in the cooking appliance according to the third embodiment of the present disclosure.

FIG. 29 is a perspective view illustrating an internal structure of a cooking appliance according to a fourth embodiment of the present disclosure in a see-through state.

FIG. 30 is a front view illustrating an internal structure of the cooking appliance illustrated in FIG. 29.

FIG. 31 is a plan view showing an internal structure of the cooking appliance shown in FIG. 29.

FIG. 32 is a side view illustrating an internal structure of the cooking appliance illustrated in FIG. 29.

FIG. 33 is a rear perspective view illustrating an internal structure of the cooking appliance illustrated in FIG. 29.

FIGS. 34 and 35 are diagrams illustrating a state in which cooking gas is discharged into an outdoor space in the cooking appliance according to the fourth embodiment of the present disclosure.

FIG. 36 is a diagram showing a state in which cooking gas is discharged into an indoor space in the cooking appliance according to the fourth embodiment of the present disclosure.

### DETAILED DESCRIPTIONS

The above-described purposes, features and advantages will be described in detail with reference to the accompanying drawings, and accordingly, a person having ordinary skill in the art to which the present disclosure belongs will be able to easily implement the technical idea of the present disclosure. In describing the present disclosure, a detailed description of known technologies related to the present disclosure will be omitted when it is determined that the gist of the present disclosure may be unnecessarily unclear. Hereinafter, preferred embodiments according to the present disclosure will be described in detail with reference to the accompanying drawings. In the drawings, the same reference numerals are used to refer to the same or similar components.

Although the first, second, and the like are used to describe various components, these components are not limited by these terms. These terms are only used to distinguish one component from another component, and it is obvious that the first component may be the second component unless there is a particular opposite description.

The present disclosure is not limited to the embodiments disclosed below. However, various changes may be applied thereto and the present disclosure may be implemented in various forms different from each other. However, the present embodiment is provided so that the present disclosure is complete and the scope of the present disclosure is fully known to those of ordinary skill in the art. Therefore, the present disclosure is not limited to the embodiments disclosed below, but it should be understood that the present disclosure includes all changes, equivalents, and substitutes included in the technical spirit and scope of the present disclosure, as well as includes replacing the configuration of one embodiment with the configuration of another embodiment and adding the configuration of another embodiment to the configuration of one embodiment.

The accompanying drawings are only set forth for the skilled person to the art to easily understand the embodiments disclosed in the present disclosure, and the technical spirit disclosed in the present disclosure is not limited by the accompanying drawings, and it should be understood that all changes, equivalents, and substitutes included in the spirit and technical scope of the present disclosure are included in the present disclosure. In the drawings, the components may be expressed in an exaggerated or small size in consideration of convenience of understanding or the like. However, the scope of protection of the present disclosure should not be limited thereto.

The terms used herein are used only to describe specific embodiments or implementations, and are not intended to limit the present disclosure. Further, the singular expression of a component includes the plural expression thereof unless the context clearly indicates otherwise. In the present disclosure, the terms “include,” “composed of”, etc. are intended to designate that the features, numbers, steps, operations, components, parts, or combinations thereof described in the present disclosure are present. That is, it should be understood that the terms such as “include” and “composed of” in the present disclosure do not exclude the possibility of the presence or addition of one or more other features, numbers, steps, operations, components, parts, or combinations thereof.

The terms including ordinals, such as first and second, may be used to describe various components, but the components are not limited by the terms. The terms are used only for the purpose of distinguishing one component from another component.

When it is mentioned that one component is “connected” or “coupled” to another component, it should be understood that one component may be directly connected or coupled to another component, or there may be still another component disposed therebetween. On the other hand, when it is stated that one component is “directly connected” or “directly coupled” to another component, it should be understood that still another component is absent therebetween.

When it is mentioned that a component is “above” or “below” another component, it should be understood that still another component may be present or absent therebetween.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In a state in which the cooking appliance is placed on the floor, a side at which the door is installed around a center of the cooking appliance is defined as a front side. Therefore, when the door is opened, the cooking target enters the cavity of the cooking appliance in a rear direction. For convenience, a front-rear direction may be referred to as a first direction. In this regard, the front side may be referred to as one side in the first direction, and the rear side may be referred to as the other side in the first direction.

In addition, the direction of gravity may be defined as a downward direction and the direction opposite to the direction of gravity may be defined as an upwardly direction.

In addition, a horizontal direction orthogonal to the front-rear direction of the cooking appliance, that is, a width direction of the cooking appliance in a front view of the door of the cooking appliance may be referred to as a left-right direction. For convenience, the left-right direction may be referred to as a second direction. Then, the right side may be referred to as one side in the second direction, and the left side may be referred to as the other side in the second direction.

In addition, the width direction of the cooking appliance may be referred to as a lateral direction. Then, the right side may be referred to as one side in the lateral direction, and the left side may be referred to as the other side in the lateral direction.

In addition, the above-described vertical direction may be referred to as a third direction. Then, the upper side may be referred to as one side in the third direction, and the lower side may be referred to as the other side in the third direction.

The front-rear direction and the left-right direction, that is, the first direction and the second direction may be first and second horizontal directions.

Throughout the present disclosure, “A and/or B” means A, B, or A and B, unless otherwise specified, and “C to D” means C inclusive to D inclusive unless otherwise specified.

### Overall Structure of Cooking Appliance

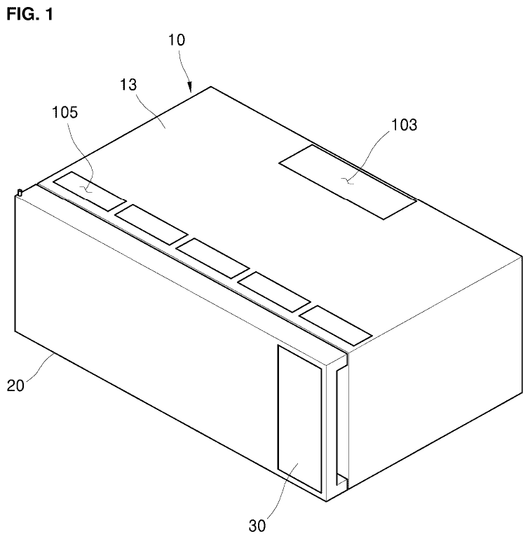

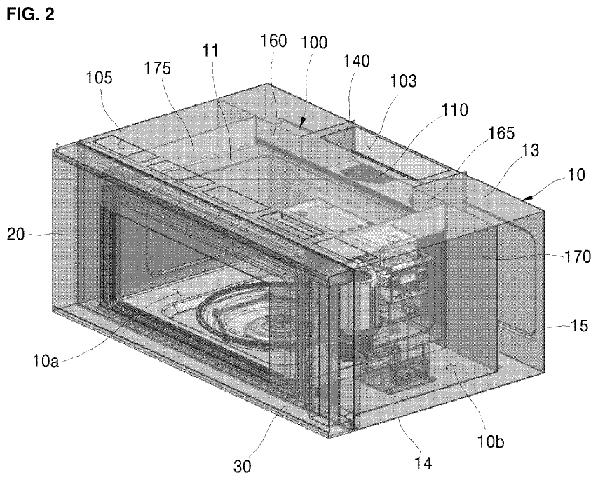

FIG. 1 is a perspective view illustrating a cooking appliance according to a first embodiment of the present disclosure. FIG. 2 is a perspective view showing an internal structure of the cooking appliance shown in FIG. 1 in a see-through state.

Referring to FIGS. 1 to 2, the cooking appliance according to an embodiment of the present disclosure has an outer appearance defined by the main body 10. The main body 10 may be provided in a shape including a substantially rectangular parallelepiped shape, and may be made of a material having a predetermined strength to protect a plurality of components installed in an inner space defined therein. The main body 10 may include a cavity 11, a cabinet 13, and a base plate 14.

The cavity 11 may constitute an internal skeleton of the main body 10. The cavity 11 may be formed in the form of a hexahedron with an open front surface. A cooking chamber 10a may be formed inside the cavity 11. The cooking chamber 10a may be formed in a shape corresponding to an inner shape of the cavity 11, that is, a hexahedral shape with an open front surface.

The cooking chamber 10a may be formed in a hexahedral shape with an open front surface. While the cooking chamber 10a is enclosed, cooking may be performed while the inner space of the cooking chamber 10a is heated. That is, in the cooking appliance, the inner space of the cooking chamber 10a is a space in which food is substantially cooked.

A front plate 12 may be disposed in front of the cavity 11. The front plate 12 may define a front appearance of the main body 10 in front of the cavity 11. In an example, the front plate 12 may be provided in the form of a metal plate having a hollow.

The cabinet 13 may define an outer appearance of the main body 10 while being disposed on an outer side of the cavity 11. The cabinet 13 may cover the cavity 11 at upper and side portions thereof and may define the outer appearance of the main body 10.

The base plate 14 may be disposed on a lower side of the cavity 11. The base plate 14 may constitute a bottom surface of the cooking appliance, and may cover the cavity 11 at a lower side of the cavity 11.

In addition, the main body 10 may further include a rear plate 15. The rear plate 15 may be disposed on a rear side of the cavity 11. The rear plate 15 may constitute a rear surface of the cooking appliance, and may cover the cavity 11 while being disposed in rear of the cavity 11.

The rear plate 15 may be integrally formed with the cabinet 13, or may be formed separately from the cabinet 13.

A door 20 for selectively opening and closing the cooking chamber 10a may be pivotably provided on a front surface of the main body 10. The door 20 may open and close the cooking chamber 10a in a side-swinging manner in which the other side in the lateral direction thereof pivots in a left or right direction around one side in the lateral direction thereof.

The door 20 may be generally formed in a hexahedral shape having a predetermined thickness. In addition, a hinge may be installed at between the main body 10 and the door 20. The hinge may be disposed on one side in the lateral direction of the main body 10 to pivotably couple one side in the lateral direction of the door 20 to the main body 10. The door 20 may be pivotably coupled to the hinge while being disposed on the front surface of the main body 10, and may open and close the cooking chamber 10a while pivoting about the hinge.

In addition, a cooking chamber heat source for heating the inside of the cooking chamber 10a is provided inside the main body 10. The cooking chamber heat source may be implemented in one type, or may be implemented in two or more types.

In the present embodiment, an example in which the cooking chamber heat source includes a magnetron capable of supplying a high frequency heat source to the inside of the cooking chamber 10a is described. In this regard, the magnetron may be installed inside the main body 10, and may be installed to be located on an upper or lower side of the cooking chamber 10a.

In addition, an electronic/electrical component chamber 10b located on an upper surface or a side surface of the cooking chamber 10a and in the main body 10 may be defined inside the main body 10. In the present embodiment, it is illustrated that the magnetron and the electronic/electrical component chamber 10b are disposed on the side surface of the cooking chamber 10a. Electronic components such as the magnetron and a high-voltage transformer may be installed inside the electronic/electrical component chamber 10b.

In addition, a control panel 30 may be provided at a front side of the main body 10. In one example, the control panel 30 may be disposed on the door 20.

The control panel 30 may be formed in a hexahedral shape having a predetermined internal space defined therein, and an input unit for inputting a manipulation signal for operating the cooking appliance by a user may be provided on a front surface of the control panel 30. A plurality of manipulation switches are provided in the input unit, and the user may directly input an operation signal thereon.

In another example, the control panel 30 may be disposed in front of the cavity 11. The control panel 30 may be disposed in an area not overlapping the cooking chamber 10a in the front-rear direction. For example, the electronic/electrical component chamber 10b may be disposed on the side surface of the cooking chamber 10a, and the control panel 30 may be disposed on the front side of the electronic/electrical component chamber 10b.

In addition, the cooking appliance of the present embodiment may further include a blower 100. In addition, the main body 10 may have an air intake hole 101, and an first exhaust hole 103 and a second exhaust hole 105.

The air blower 100 may be accommodated in the cooking appliance, and may suction the cooking gas through the air intake hole 101 and discharge the suctioned cooking gas to the outside out of the cooking appliance through at least one of the first exhaust hole 103 and the second exhaust hole 105.

### Overall Structure of Components Related to Hood Function

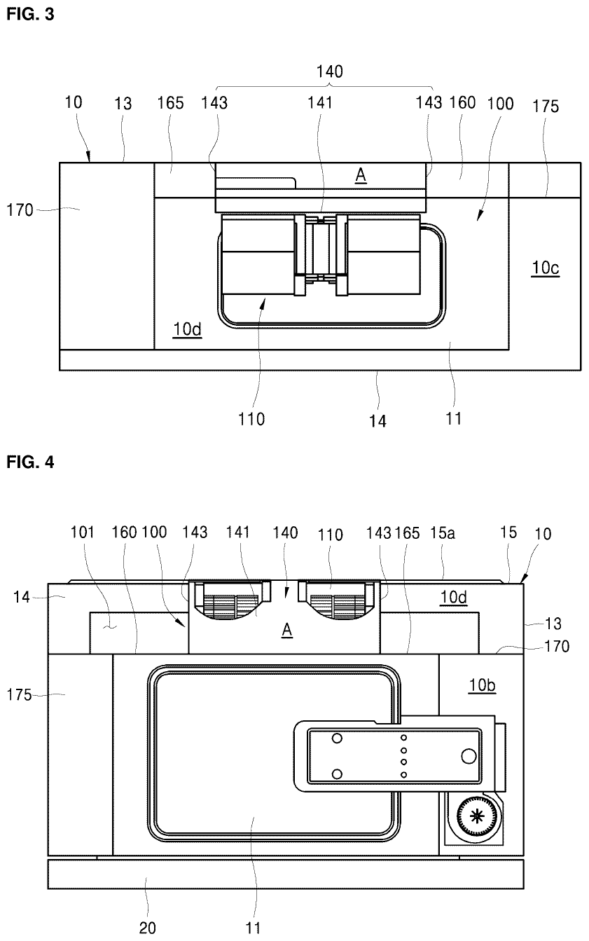

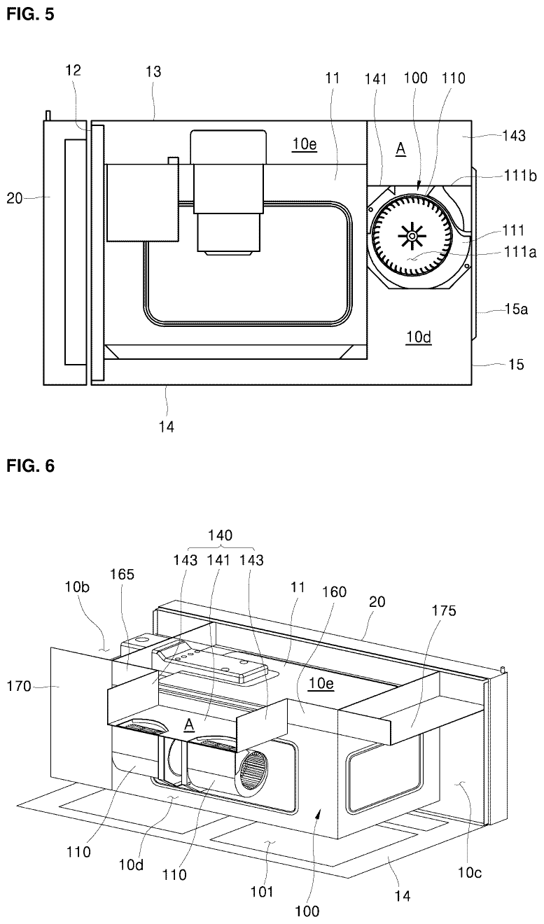

FIG. 3 is a front view showing an internal structure of the cooking appliance shown in FIG. 1, and FIG. 4 is a plan view showing an internal structure of the cooking appliance shown in FIG. 1. FIG. 5 is a side view illustrating an internal structure of the cooking appliance shown in FIG. 1, and FIG. 6 is a rear perspective view illustrating an internal structure of the cooking appliance shown in FIG. 1.

Referring to FIGS. 2 to 6, the air intake hole 101 may be disposed in a lower end of the cooking appliance. In one example, the air intake hole 101 may be defined in the base plate 14. The air intake hole 101 may constitute a passage for introducing the cooking gas into the cooking appliance such that the passage is defined at the lower end of the cooking appliance. In the present embodiment, it is illustrated that each of a pair of air intake holes 101 are disposed below a side space 10c as will be described below.

The first exhaust hole 103 and the second exhaust hole 105 may be disposed in an upper end of the cooking appliance. The first exhaust hole 103 and the second exhaust hole 105 may constitute a passage for discharging the cooking gas suctioned into the cooking appliance to the outside out of the cooking appliance such that the passage is defined in the upper end of the cooking appliance.

In one example, the first exhaust hole 103 and the second exhaust hole 105 may be defined in the upper surface of the cabinet 13. The first exhaust hole 103 and the second exhaust hole 105 may be formed in the upper surface of the cabinet 13 so as to extend through the cabinet 13 in a vertical direction.

The first exhaust hole 103 may be disposed in a rear portion of the upper surface of the main body 10. In addition, the second exhaust hole 105 may be disposed at the front side of the upper surface of the main body 10. That is, the second exhaust hole 105 may be disposed at a side thereof adjacent to the door 20, and may be disposed to be closer to the front side than the first exhaust hole 103 may be.

The first exhaust hole 103 may constitute a passage for discharging the cooking gas suctioned into the cooking appliance to the outside. The second exhaust hole 105 may constitute a passage for discharging the cooking gas suctioned into the cooking appliance into an indoor room.

In one example, the first exhaust hole 103 may be disposed in an area overlapping an upper cabinet in which the cooking appliance is received in the vertical direction. In addition, the second exhaust hole 105 may be disposed at a position protruding in a frontward direction beyond the upper cabinet.

In addition, the first exhaust hole 103 may be disposed approximately at a center in the lateral direction of the main body 10. In addition, a plurality of second exhaust holes 105 may be arranged in the lateral direction and may be positioned at the front side of the upper surface of the main body 10.

The first exhaust hole 103 disposed approximately at the center in the lateral direction of the main body 10 as described above may be connected to an exhaust duct connected to the outdoor. The plurality of second exhaust holes 105 arranged in the lateral direction may discharge the cooking gas from a position in front of the upper cabinet to a position above the cooking appliance. In this regard, the cooking gas may be discharged through the second exhaust hole 105 in a state of being filtered inside the cooking appliance.

A space may be formed in the main body 10. The space may be disposed between the cavity 11 and the cabinet 13.

The space may be divided into the side space 10c and a rear space 10d. The side space 10c may be disposed on each of both opposing sides in the lateral direction of the cavity 11. In addition, the rear space 10d may be disposed on the rear side of the cavity 11.

For example, each side space 10c may be a space defined between each side surface of the cavity 11 and each side surface of the cabinet 13. In addition, the rear space 10d may be a space defined between the rear surface of the cavity 11 and the rear plate 15.

The electronic/electrical component chamber 10b may be disposed in one of the side spaces 10c. In the present embodiment, it is illustrated that the electronic/electrical component chamber 10b is provided in the side space 10c disposed in rear of the control panel 30.

The blower 100 may be disposed inside the main body 10. More specifically, the air blower 100 may be disposed in the space, that is, the space between the cavity 11 and the cabinet 13. The blower 100 may include at least one fan assembly 110.

The fan assembly 110 may generate an airflow for suctioning the cooking gas outside the cooking appliance and discharging the cooking gas to the outside out of the cooking appliance. The fan assembly 110 may introduce the cooking gas into the main body 10 through the air intake hole 101 and discharge the introduced cooking gas through at least one of the first exhaust hole 103 and the second exhaust hole 105 out of the main body.

At least one of the fan assembly 110 provided in the blower 100 may be disposed in the rear space 10d. Accordingly, the cooking gas introduced into the main body 10 through the air intake hole 101 may flow through the rear space 10d and then be discharged through the first exhaust hole 103 or the second exhaust hole 105. A detailed arrangement structure of the fan assembly 110 will be described later.

In addition, an upper space 10e may be further provided inside the main body 10. The upper space 10e may be disposed above the cavity 11.

For example, the upper space 10e may be defined between the upper surface of the cavity 11 and the upper surface of the cabinet 13. The upper space 10e may be connected to the rear space 10d.

That is, the air introduced into the rear space 10d may flow through the upper space 10e and be discharged to the outside out of the cooking appliance through the first exhaust hole 103 or the second exhaust hole 105. In addition, the air introduced into the side space 10c may also flow through the upper space 10e and may be discharged to the outside out of the cooking appliance through the first exhaust hole 103 or the second exhaust hole 105.

### First Embodiment of Blower

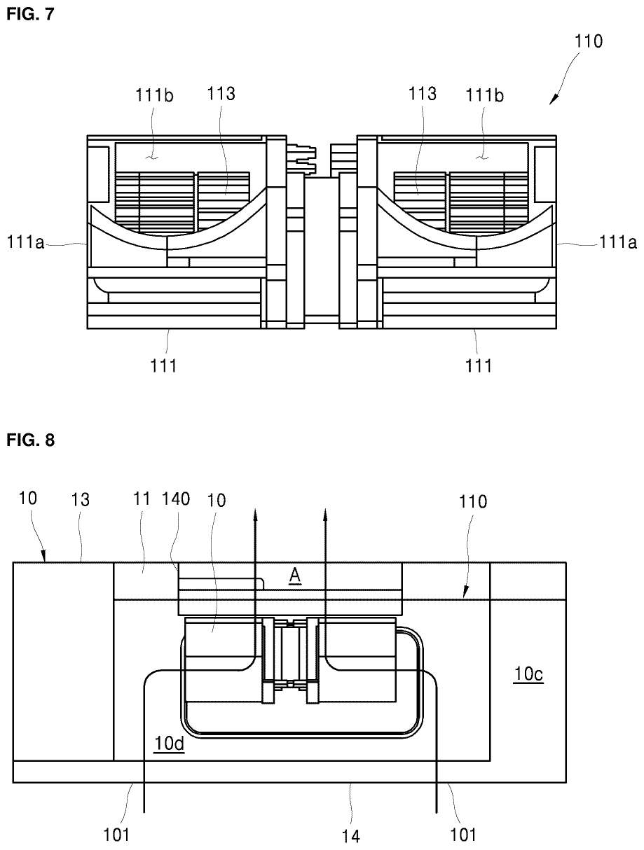

FIG. 7 is a plan view illustrating a fan assembly separated from the cooking appliance as shown in FIG. 6.

Referring to FIGS. 2 to 7, the blower 100 may include at least one fan assembly. The fan assembly 110 may include a fan housing 111, an impeller 113, and a fan motor.

The fan housing 111 may define an outer appearance of the fan assembly 110, and may accommodate the impeller 113 therein. A suction hole 111a may be formed at a side portion of the fan housing 111. A suction hole 111a may constitute a passage necessary for the air outside the fan assembly 110 to be suctioned into the impeller 113 in the fan housing 111.

In the present embodiment, the fan housing 111 is illustrated as being formed in a shape including a horizontally extending cylindrical shape in which both opposing sides thereof are open, and each of both opposing open sides of the fan housing 111 may be provided as the suction hole 111a.

An accommodation space for accommodating the impeller 113 therein may be formed in the fan housing 111.

The accommodation space for accommodating the impeller 113 therein may be formed inside the fan housing 111. In addition, an inner circumferential surface of the fan housing 111 defining the accommodation space may be formed as a curved surface surrounding an outer circumferential surface of the impeller 113.

A discharge hole 111b may be provided at an upper side of the fan housing 111. The discharge hole 111b constitutes a passage through which air suctioned into the accommodation space in which the impeller 113 is accommodated is discharged to the outside of the blower 100.

The discharge hole 111b may be formed to extend through the fan housing 111 in the vertical direction. Accordingly, the air suctioned into the fan housing 111 in a lateral direction through the suction hole 111a may be discharged to a position on top of the fan housing 111 through the discharge hole 111b.

The impeller 113 is constructed to be rotated about an axis extending in the lateral direction. A space into which air suctioned through a side portion of the impeller 113 is introduced is formed inside the impeller 113.

The impeller 113 may be connected to a rotation shaft of the fan motor. The rotation shaft of the fan motor rotates about an axis extending in a lateral direction, and the impeller 113 connected to the rotation shaft of the fan motor may rotate about an axis extending in a lateral direction together with the rotation shaft of the fan motor.

The fan assembly 110 provided as described above may be disposed inside the main body 10 and may be disposed in at least one of the side space 10c and the rear space 10d.

According to the present embodiment, the blower 100 may include at least one fan assembly 110 disposed in the rear space 10d. In the present embodiment, an example is illustrated in which one fan assembly 110 disposed in the rear space 10d constitutes the blower 100.

In an example, the fan assembly 110 may be configured to include a pair of impellers 113. The fan assembly 110 may be provided in a structure in which a fan motor is disposed between a pair of impellers 113 arranged in a lateral direction. Hereinafter, the fan assembly 110 of this type will be referred to as a first fan assembly.

In the first fan assembly 110, the fan motor may rotate both a pair of impellers 113 respectively disposed on both opposing sides thereof. In addition, the both impellers 113 may be respectively accommodated in a pair of fan housings 111 respectively disposed on both opposing sides of the fan motor.

As described above, the first fan assembly 110 including one fan motor, the pair of impellers 113, and the fan housing 111 may be configured to suction air through the pair of suction holes 111a respectively disposed at both opposing sides in the lateral direction of the first fan assembly 110 and discharge air through the pair of discharge holes 111b disposed at the upper side of the first fan assembly 110.

According to the present embodiment, the blower 100 may be configured to include one first fan assembly 110. In addition, the first fan assembly 110 may be disposed in the rear space 10d, that is, in a space defined between the rear surface of the cavity 11 and the rear plate 15.

In addition, the first fan assembly 110 may be disposed at the center in the lateral direction of the rear space 10d. That is, the first fan assembly 110 may be disposed approximately in the center area of the rear space of inside the cooking appliance.

According to the present embodiment, the first exhaust hole 103 may be disposed approximately at the center in the lateral direction of the main body 10, and may be disposed at a position closer to the rear side of the cabinet 13 and may be defined in the upper surface of the cabinet 13. That is, the first exhaust hole 103 may be disposed at a position overlapping the rear space 10d in the vertical direction.

The blower 100 of the present embodiment may include a first blower and a second blower. The first blower may be disposed in rear of the cavity 11, and the second blower may be disposed on a side of the cavity 11. That is, the first blower may be disposed in the rear space 10d, and the second blower may be disposed in the side space 10c.

Hereinafter, among the first fan assembly 110 and the second fan assembly 120, one disposed in the rear space 10d will be referred to as the first blower, and those disposed in the side space 10c will be referred to as the second blower.

In the present embodiment, it is illustrated that the first blower includes the first fan assembly 110 and the second blower includes the second fan assembly 120.

In the cooking appliance of the present embodiment, both the first exhaust hole 103 and the first fan assembly 110 may be disposed in the rear space 10d, and the first exhaust hole 103 and the first fan assembly 110 may be arranged in the vertical direction and be disposed in the rear space 10d.

In one example, a rearward protruding surface 15a may be provided on the rear plate 15 of the present embodiment. The rearward protruding surface 15a may constitute a surface that protrudes rearwards beyond the remaining area of the rear plate 15 except for the rearward protruding surface 15a.

For example, the rear plate 15 may constitute a plane orthogonal to the front-rear directional axis. In addition, the rearward protruding surface 15a may constitute a plane parallel to the rear plate 15, and may be disposed at a position protruding rearwards beyond the remaining area of the rear plate 15 except for the rearward protruding surface 15a. Preferably, the rearward protruding surface 15a may be disposed at the center in the lateral direction and the vertical direction of the rear plate 15.

The first fan assembly 110 may be disposed in front of the rear plate 15 and may be disposed in an area overlapping the rearward protruding surface 15a in the front-rear direction. Accordingly, the first fan assembly 110 may be disposed at a position protruding rearwards beyond the remaining area of the rear plate 15 except for the rearward protruding surface 15a, and may be disposed at a position further protruding rearwards by a length by which the rearward protruding surface 15a protrudes rearwards.

The rearward protruding surface 15a provided as described above may contribute to securing a space required for the installation of the blower 100 in the rear space 10d.

That is, the rearward protruding surface 15a may contribute to allowing the first fan assembly 110 having a larger size and higher performance to be applied to the blower 100.

In addition, the rearward protruding surface 15a may serve as a structure used to space the wall surface on which the cooking appliance is installed from the rear surface of the cooking appliance.

In one example, the cooking appliance of the present embodiment may include flow path defining member 140. The flow path defining member 140 is constructed to induce the flow of air discharged from the blower 100.

The flow path defining member 140 may define an exhaust flow path A inside the cooking appliance. The exhaust flow path A may connect the blower 100 and the upper space 10e to each other, and may guide the flow of air into the upper space 10e from the first fan assembly 110. The exhaust flow path A may guide the flow of air discharged from the blower 100 toward the exhaust hole 103 and 105. In one example, the exhaust flow path A may be disposed in the rear space 10d.

An inlet of the exhaust flow path A may be opened toward the first fan assembly 110. An outlet of the exhaust flow path A may be opened toward the upper space 10e. That is, the exhaust flow path A may constitute a flow path for guiding the flow of air from the discharge hole 111b of the first fan assembly 110 to the upper space 10e inside the cooking appliance.

The flow path defining member 140 may include a fastening plate 141 and a pair of vertical plates 143.

The fastening plate 141 may be installed on the fan assembly 110. The fastening plate 141 may open the discharge hole 111b upwardly and be coupled to the upper surface of the fan assembly 110.

The vertical plate 143 may constitute a vertical wall extending upwardly from the fastening plate 141. The pair of vertical plates 143 may be disposed to be spaced apart from each other by a predetermined spacing in the lateral direction with the fastening plate 141 interposed therebetween.

In an example, one of the pair of vertical plates 143 may be connected to an end of one side in the lateral direction of the fastening plate 141, and the other of the pair of vertical plates 143 may be connected to an end of the other side in the lateral direction of the fastening plate 141.

In the flow path defining member 140, the fastening plate 141 may define a lower boundary surface of the first flow path A1, and the pair of vertical plates 143 may define a left boundary surface and a right boundary surface of the first flow path A1. A rear boundary surface and a front boundary surface of the first flow path A1 may be formed defined by the rear surface of the cavity 11 and the rear plate 15, respectively.

The pair of vertical plates 143 are constructed to protrude upwardly beyond the upper surface of the cavity 11. In an example, the vertical plate 143 may protrude to a vertical level such that an upper end of the vertical plate 143 contacts the upper surface of the cabinet 13.

Accordingly, the outlet of the first flow path A1 may be connected only to the upper space 10e, and the flow of air discharged from the first fan assembly 110 may be guided only to the upper space 10e through the first flow path A1.

In addition, the cooking appliance of the present embodiment may further include a first partitioning member 170. The first partitioning member 170 may constitute a blocking wall that blocks the electronic/electrical component chamber 10b and the upper space 10e from each other, and blocks the electronic/electrical component chamber 10b and the first fan assembly 110 from each other.

The first partitioning member 170 may prevent the air in the upper space 10e from flowing back to the electronic/electrical component chamber 10b, and may prevent the air in the upper space 10e from flowing back to the first fan assembly 110 through the electronic/electrical component chamber 10b.

In addition, the cooking appliance of the present embodiment may further include a second partitioning member 175. The second partitioning member 175 is constructed to block the side space 10c and the upper space 10e from each other. In an example, the second partitioning member 175 may include a horizontal plate that vertically blocks the side space 10a and the upper space 10e from each other, and a vertical plate that horizontally blocks the side space 10c and the upper space 10e from each other.

In addition, the cooking appliance of the present embodiment may further include a first connection plate 160. The first connection plate 160 is constructed to block the flow path defining member 140 and the side space 10c from each other.

In an example, the first connection plate 160 is constructed to connect the vertical plate 143 of the flow path defining member 140 and the second partitioning member 175 of the second flow path defining member 150 to each other. The first connection plate 160 may block a gap between the flow path defining member 140 and the second partitioning member 175 to prevent the air in the upper space 10e from flowing backward to the rear space 10d and the first fan assembly 110 through the gap between the flow path defining member 140 and the second partitioning member 175.

In addition, the cooking appliance of the present embodiment may further include a second connection plate 165. The second connection plate 165 is constructed to block a gap between the flow path defining member 140 and the first partitioning member 170.

In an example, the second connection plate 165 is constructed to connect the vertical plate 143 of the flow path defining member 140 and the first partitioning member 170 to each other. The first connection plate 160 may block the gap between the flow path defining member 140 and the first partitioning member 170 to prevent the air in the upper space 10e from flowing backward to the rear space 10d and the first fan assembly 110 through the gap between the flow path defining member 140 and the first partitioning member 170.

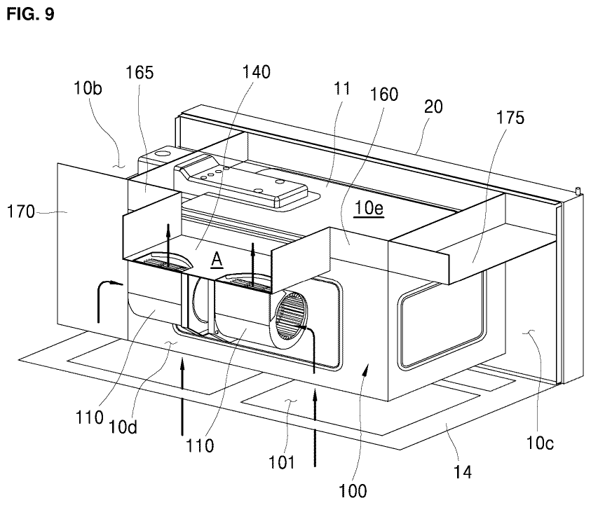

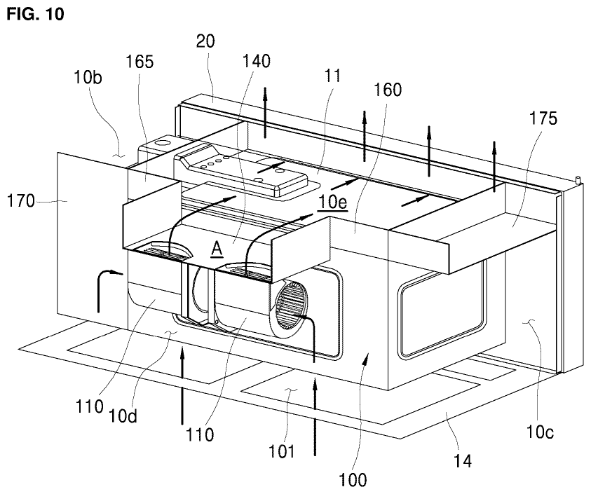

FIG. 7 and FIG. 8 are diagrams showing a state in which cooking gas is discharged to an outdoor space in the cooking appliance according to the first embodiment of the present disclosure, and FIG. 9 and FIG. 10 are diagrams showing a state in which cooking gas is discharged to an indoor space in the cooking appliance according to the first embodiment of the present disclosure.

Hereinafter, an operation and an effect of the cooking appliance will be described with reference to FIGS. 7 to 10.

Referring to FIGS. 7 and 8, the air intake hole 101 may be provided in a lower end of the cooking appliance, and the first exhaust hole 103 and the second exhaust hole 105 may be provided in an upper end of the cooking appliance. The first exhaust hole 103 may be disposed to be closer to the rear side of the cooking appliance, and the second exhaust hole 105 may be disposed to be closer to the front side of the cooking appliance.

The blower 100 may include the fan assembly 110, and the first fan assembly 110 may be disposed in the rear space 10d. The first fan assembly 110 may be disposed in the center in the lateral direction of the rear space 10d. Preferably, the first fan assembly 110 may be disposed at a position overlapping the first exhaust hole 103 in the vertical direction.

When the operation of the first fan assembly 110 starts, suctioning airflow for suctioning air outside the cooking appliance into the cooking appliance may be generated. The suctioning airflow generated as described above acts on the external air to be suctioned through the air intake hole 101 disposed at the lower end of the cooking appliance. The external air around the air intake hole 101, that is, the cooking gas may flow through the air intake hole 101 and be suctioned into the main body 10 under the suctioning airflow acting in this way.

The cooking gas suctioned into the main body 10 may be introduced into the rear space 10d among the spaces inside the main body 10. The cooking gas introduced into the rear space 10d as described above may be suctioned into the first fan assembly 110 through the suction holes 111a respectively disposed at both opposing sides of the fan assembly 110, and then discharged to a position on top of the first fan assembly 110 through the discharge holes 111b respectively disposed at the upper side of the fan assembly 110.

That is, the cooking gas introduced into the main body 10 through the air intake hole 101 may flow to the upper space 10e through the rear space 10d. The cooking gas having flowed to the upper space 10e may be discharged to the outside through the first exhaust hole 103.

The first exhaust hole 103 may constitute a passage connecting the upper space 10e to the outside out of the cooking appliance. The first exhaust hole 103 may be disposed above the upper space 10e, and may be disposed at a position overlapping the rear space 10d in the vertical direction.

That is, the fan assembly 110, the rear space 10d, and the first exhaust hole 103 may be disposed so as to overlap each other in the vertical direction. Preferably, the fan assembly 110, the rear space 10d, and the first exhaust hole 103 may be aligned with each other in a line along the vertical direction.

Accordingly, the flow of air under the operation of the first fan assembly 110 may have the same straight line direction as the alignment direction of the fan assembly 110, the rear space 10d, and the first exhaust hole 103.

As described above, when the air flows in the straight line direction, the resistance to the air flow is lowered so that the air flow may be performed more smoothly. Accordingly, air suction and discharge performance by the first fan assembly 110 may be improved, thereby improving the cooking gas removal performance of the cooking appliance.

In one example, the cooking appliance of the present embodiment, as shown in FIG. 9 and FIG. 10, may discharge the cooking gas suctioned into the cooking appliance into the indoor space as necessary.

According to the present embodiment, a passage for discharging the cooking gas suctioned into the cooking appliance into the indoor space may be composed of the second exhaust hole 105. That is, the cooking gas introduced into the rear space 10d through the air intake hole 101 may flow through the upper space 10e and then be discharged to the indoor space through the second exhaust hole 105.

The cooking gas having flowed from the rear space 10d to the upper space 10e may flow through a filter and be discharged into the indoor room through the second exhaust hole 105 in the state as filtered by the filter.

According to the present embodiment, the first fan assembly 110 may be disposed in the rear side of the main body 10 adjacent to the rear plate 15, and the second exhaust hole 105 may be disposed in a front side of the upper surface of the main body 10 adjacent to the door 20.

That is, the second exhaust hole 105 may be disposed to communicate with the front side of the upper space 10e, and the first fan assembly 110 may be disposed in rear of the upper space 10e. The first exhaust hole 103 may be disposed to communicate with a rear side of the upper space 10e.

According to the present embodiment, a filter for filtering the cooking gas may be provided in the upper space 10e. In the upper space 10e, the first fan assembly 110 and the second exhaust hole 105 are sufficiently spaced from each other in the front-rear direction or the first exhaust hole 103 and the second exhaust hole 105 are sufficiently spaced from each other in the front-rear direction. Thus, a sufficient space required for installing the filter may be secured in the upper space 10e.

That is, the blower 100 is disposed in an space constituting a rear area of the main body 10, that is, the rear space 10d, such that a sufficient space required for installing the filter may be secured in the upper space 10e.

If the blower 100 is disposed in the upper space 10e, a significant portion of the upper space 10e is occupied with the blower 100, such that it is difficult to secure a space required for installing the filter in the upper space 10e. In addition, if the blower 100 is disposed in the upper space 10e, there may be a problem in that the vertical length of the cooking appliance is increased.

In consideration of this fact, in the cooking appliance of the present embodiment, the blower 100 is disposed in the rear space 10d. Accordingly, in the cooking appliance of the present embodiment, the installation space of the filter may be effectively secured in the upper space 10e while not increasing the vertical length of the cooking appliance.

In the cooking appliance of the present embodiment employing the structure in which the blower 100 is disposed in the rear space 10d as described above, the flow of air involved in suctioning the cooking gas and discharging the cooking gas through the first exhaust hole 103 is performed in the linear direction, so that the flow loss inside the cooking appliance is minimized, thereby providing a more improved cooking gas removal performance.

In addition, in the cooking appliance of the present embodiment, the filter installation space may be effectively secured in the upper space 10e, thereby providing an effect of maintaining a compact size and smoothly filtering and discharging the cooking gas to the indoor space.

The space inside the main body 10 may be divided into the side space 10c, the rear space 10d, and the upper space 10e as described above. The blower 100 of the present embodiment is disposed in the rear space 10d rather than the side space 10c or the upper space 10e.

In general, the lateral length of the side space 10c in which the electronic/electrical component chamber is not disposed is set to be smaller than the length in the front-rear direction of the rear space 10d. That is, the side space 10c may provide only a space narrower than the rear space 10d.

Various devices may be disposed in the rear space 10d according to the type of the cooking appliance. For example, in the cooking appliance providing a convection function, a convection module may be disposed in the rear space 10d.

On the other hand, it is very rare that the devices are disposed in the side space 10c that does not constitute the electronic/electrical component chamber 10b. Therefore, the lateral width of the side space 10c does not need to be unnecessarily increased. When the lateral length of the side space 10c unnecessarily increases, only the overall size of the cooking appliance is increased regardless of whether the performance of the cooking appliance is improved or not.

In consideration of this fact, the side space 10c is formed to provide a space narrower than the rear space 10d.

In order to reduce the cost, it is common for cooking appliances of different types having the same cooking chamber volume to employ the main body 10 of the same size. For example, a cooking appliance that provides both a high-frequency function and a convection function may be manufactured using the main body 10 of the same size as that of the main body which a cooking appliance that provides only the high-frequency function employs.

Accordingly, the main body 10 of the present embodiment may include the rear space 10d providing a space suitable for receiving therein the convection module, and the side space 10c may be formed in a form providing only a space narrower than the rear space 10d.

In consideration of this fact, the blower 100 of the present embodiment may be disposed in the rear space 10d that provides a more sufficient space than the side space 10c provides. Since the blower 100 is disposed in the rear space 10d as described above, flow loss in the cooking appliance may be reduced as described above, and a larger fan assembly having high performance may be applied to the blower 100.

That is, the cooking appliance of the present embodiment including the blower 100 disposed in the rear space 10d may provide more improved cooking gas removal performance while suppressing an increase in the size of the cooking appliance using the main body 10 of a commonly used size.

### Second Embodiment of Blower

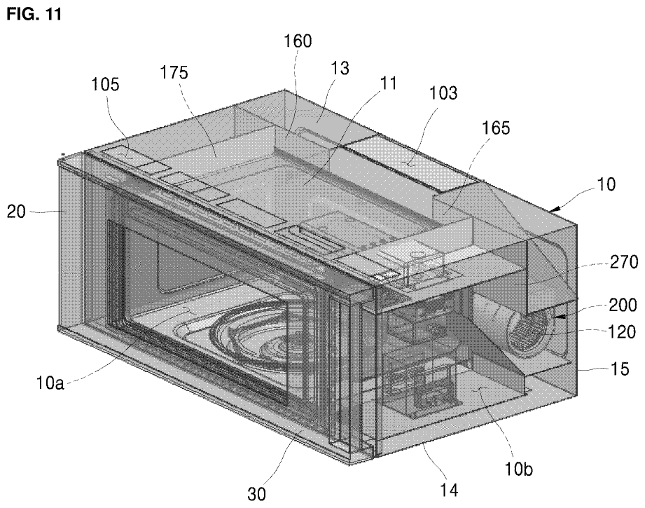

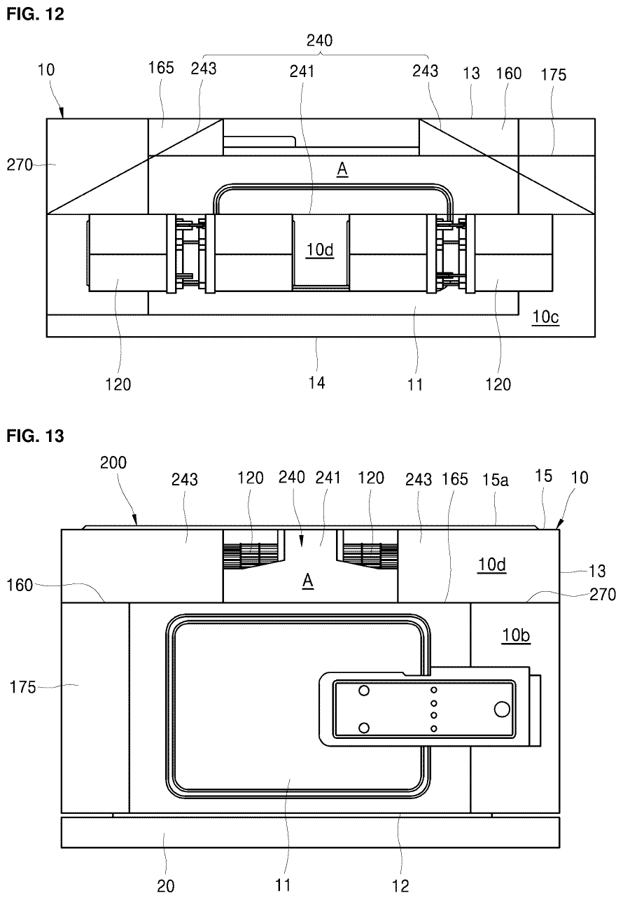

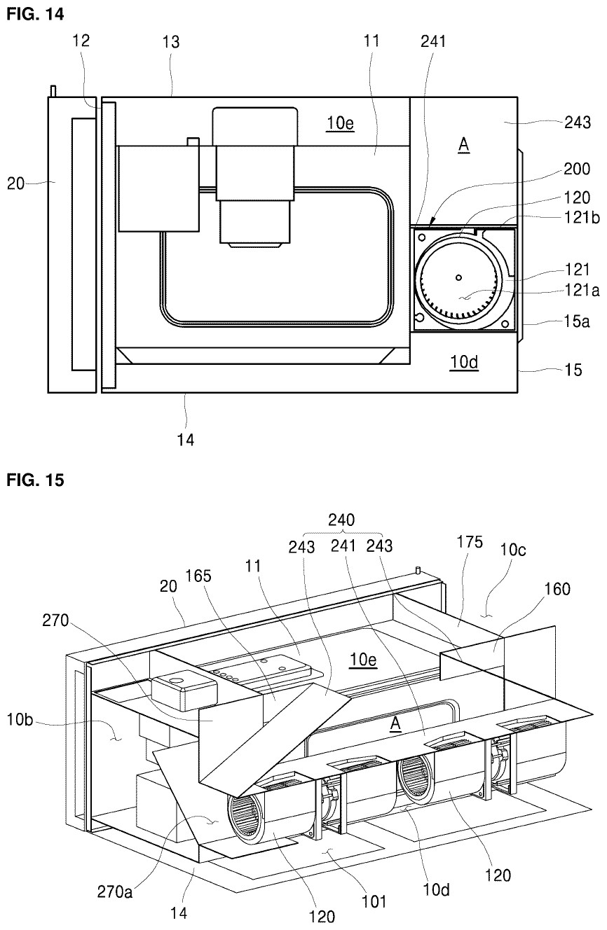

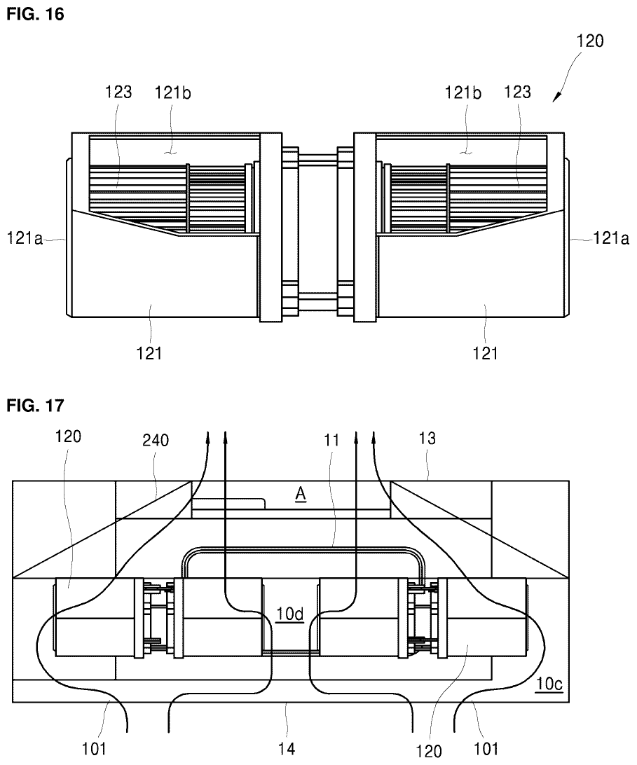

FIG. 11 is a perspective view showing an internal structure of a cooking appliance according to a second embodiment of the present disclosure in a see-through state, FIG. 12 is a front view showing an internal structure of the cooking appliance shown in FIG. 11, and FIG. 13 is a plan view showing an internal structure of the cooking appliance shown in FIG. 11. FIG. 14 is a side view showing the internal structure of the cooking appliance shown in FIG. 11, FIG. 15 is a rear perspective view showing the internal structure of the cooking appliance shown in FIG. 11, and FIG. 16 is a plan view showing the fan assembly separated from the cooking appliance as shown in FIG. 11.

Referring to FIGS. 11 to 16, a blower 200 may include a plurality of fan assemblies 210. In the present embodiment, the blower 200 is illustrated as including a pair of fan assemblies 210.

According to the present embodiment, the blower 200 may include a second fan assembly 120 provided in a slightly smaller size than that of the first fan assembly 110 (see FIG. 6) illustrated in the above-described embodiment.

In an example, the second fan assembly 120 may include a fan housing 211, an impeller 213, and a fan motor, which are the same as or similar to those of the first fan assembly 110, and may include the fan housing 211 and the impeller 213, which are smaller in size than those provided in the first fan assembly 110. The arrangement positions of the suction hole 211a and the discharge hole 211b are the same as those of the first fan assembly 110.

Accordingly, the second fan assembly 120 according to the present embodiment may be provided in a form having a slightly smaller size than that of the first fan assembly 110 and having slightly lower suction or discharge performance than that of the first fan assembly 110. In particular, the second fan assembly 120 may be constructed to have a length in the front-rear direction smaller than that of the first fan assembly 110.

According to the present embodiment, although the blower 200 includes the second fan assembly 120 that provides performance somewhat lower than that of the first fan assembly 110, the blower 200 may be configured to include a plurality of second fan assemblies 120.

That is, since the blower 200 includes the plurality of second fan assemblies 120 having slightly lower performance but smaller size than those of the first fan assembly 110, the blower 200 may provide suction or discharge performance equal to or higher than that of the blower 100 (see FIG. 2) illustrated in the above-described embodiment.

In summary, in the present embodiment, the second fan assembly 120 having a smaller size than that of the first fan assembly 110 is applied to the blower 200, and accordingly, the blower 200 may be configured to include a larger number of fan assemblies 210 than the number of fan assemblies included in the blower 100 illustrated in the above-described embodiment.

The blower 200 including the plurality of second fan assemblies 120 as described above may provide the suction or discharge performance higher than that of the blower 100 illustrated in the above-described embodiment. Accordingly, the cooking appliance of the present embodiment may provide more improved cooking gas removal performance.

In addition, as the second fan assembly 120 having a size smaller than that of the first fan assembly 110 is applied to the blower 200, the size of the rear space 10d to be secured for installing the blower 200 therein may be reduced. That is, as the length in the front-rear direction of the second fan assembly 120 is shortened, the length in the front-rear direction of the rear space 10d may be shortened, which may lead to a result that the length in the front-rear direction of the cooking appliance is shortened.

In other words, since the blower 200 is provided so as to include a plurality of second fan assemblies 120 having a size slightly smaller than that of the fan assembly 110, the cooking gas removal performance of the cooking appliance may be improved and the size of the cooking appliance may be further reduced.

In addition, the cooking appliance of the present embodiment may include a flow path defining member 240 and 250. Like the flow path defining member illustrated in the above-described embodiment, the flow path defining member 240 and 250 may constitute the exhaust flow path A inside the cooking appliance.

In the present embodiment, an example is illustrated in which the flow path defining member 240 and 250 includes a first flow path defining member 240 and a second flow path defining member 250. The first flow path defining member 240 may be constructed to induce flow of air discharged from the fan assembly 110, and the second flow path defining member 250 may be constructed to induce flow of air discharged from the second fan assembly 120.

The first flow path defining member 240 may include a fastening plate 241 and a pair of inclined plates 243.

The fastening plate 241 may be installed on the second fan assembly 120 disposed in the rear space 10d. The fastening plate 241 may open the discharge hole 121b upwardly and be coupled to the upper surface of the second fan assembly 120.

In an example, the fastening plate 241 may be constructed to cover all of the plurality of second fan assemblies 120 disposed in the rear space 10d while being positioned on top thereof. The fastening plate 241 may be formed to have a length corresponding to a total length in a lateral direction of the plurality of second fan assemblies 120 disposed in the rear space 10d, and may be coupled to an upper surface of each of the plurality of second fan assemblies 120 disposed in the rear space 10d.

The inclined plate 243 may constitute a vertical wall extending upwardly from the fastening plate 241. The pair of inclined plates 243 may be disposed to be spaced apart from each other by a predetermined spacing in the lateral direction with the fastening plate 241 interposed therebetween.

In an example, one of the pair of inclined plates 243 may be connected to one side end in the lateral direction of the fastening plate 241, and the other of the pair of inclined plates 243 may be connected to the other side end in the lateral direction of the fastening plate 241.

Each of the inclined plates 243 may be formed in a shape extending upwardly from the fastening plate 241. Each of the inclined plates 243 may constitute an inclined surface extending upwardly so as to be inclined toward the lateral center of the rear space 10d. The inclined plate 243 may guide the flow of air flowing through the exhaust flow path A to the lateral center of the rear space 10d.

The inclined plate 243 is constructed to protrude upwardly beyond the upper surface of the cavity 11. In an example, the inclined plate 243 may protrude to a vertical level such that an upper end of the inclined plate 243 contacts the upper surface of the cabinet 13.

Accordingly, the outlet of the exhaust flow path A may be connected only to the upper space 10e, and the flow of air discharged from the second fan assembly 120 may be guided only to the upper space 10e through the exhaust flow path A.

In one example, in the present embodiment, a ventilation hole 270a may be defined in the first partitioning member 270. The ventilation hole 270a may be formed in a portion of the first partitioning member 270 that blocks the electronic/electrical component chamber 10b and the rear space 10d from each other. In an example, the ventilation hole 270a may be formed so as to extend through a portion of the first partitioning member 270 adjacent to the second fan assembly 120 disposed in the rear space 10d in the front-rear direction.

The ventilation hole 270a may constitute a passage defined in the first partition member 270 necessary for air inside the electronic/electrical component chamber 10b to flow toward the second fan assembly 120 disposed in the rear space 10d.

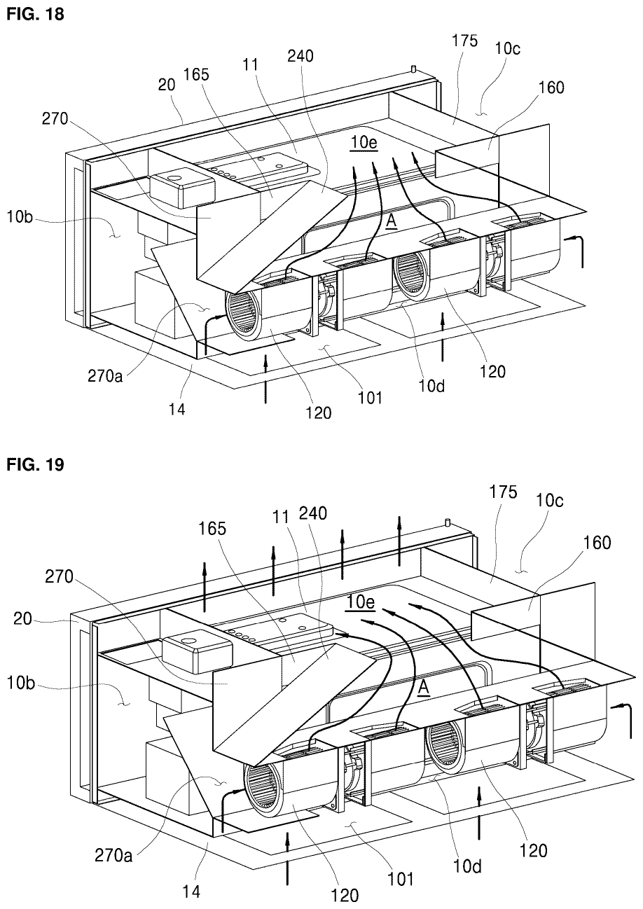

FIGS. 17 and 18 are diagrams illustrating a state in which cooking gas is discharged into an outdoor space in the cooking appliance according to the second embodiment of the present disclosure. FIG. 19 is a diagram showing a state in which cooking gas is discharged into an indoor space in the cooking appliance according to the second embodiment of the present disclosure.

As illustrated in FIGS. 17 and 18, the cooking appliance of the second embodiment of the present disclosure may suction the cooking gas outside the cooking appliance into the cooking appliance through the air intake hole 101, and discharge the cooking gas suctioned by the blower 200 to the outside through the first exhaust hole 103. In addition, the cooking appliance may discharge the cooking gas suctioned into the cooking appliance into the indoor space through the second exhaust hole 105 as illustrated in FIG. 18.

According to the present embodiment, the plurality of second fan assemblies 120 may be laterally arranged and disposed inside the main body 10. Each of the second fan assemblies 120 disposed as described above may be disposed adjacent to a pair of air intake holes 101 arranged in the lateral direction and defined in the lower end of the main body 10, respectively.

That is, when a pair of second fan assemblies 120 are arranged in the lateral direction, the distance between the second fan assembly 120 and the air intake hole 101 is also shortened, compared to when one fan assembly is disposed in the lateral center of the main body 10. Thus, the flow path connecting the second fan assembly 120 and the air intake hole 101 to each other may be formed in a shape approximate to a straight line in the vertical direction.

As a result, the suction performance of the blower 200 may be improved as the distance between the second fan assembly 120 and the air intake hole 101 is shortened. As the shape of the flow path is formed in a shape approximate to the straight line, the resistance to air flow may also be lowered.

That is, as the plurality of second fan assemblies 120 are laterally arranged inside the main body 10 as described above, a flow loss inside the cooking appliance is minimized, and accordingly, the cooking gas removal performance of the cooking appliance may be further improved.

In one example, referring to FIGS. 17 to 19, the second fan assembly 120 may be disposed in the main body 10, and may be disposed at a position lower than a position at which the first fan assembly 110 (see FIG. 3) is disposed in the above-described embodiment.

For example, compared to the case in which of the first fan assembly 110 is disposed at a vertical level equal to or higher than a vertical level of a center point in the vertical direction of the main body 10, the second fan assembly 120 of the present embodiment may be disposed at a vertical level lower than the vertical level of the center in the vertical direction of the main body 10.

According to the present embodiment, the first exhaust hole 103 may be disposed in the rear side of the upper surface of the main body 10, and may be disposed at the lateral center of the main body 10. In contrast thereto, the pair of second fan assemblies 120 are disposed at a position offset laterally from the lateral center of the main body 10.

As described above, the second fan assembly 120 is disposed at a position closer to the lateral side of the main body 10. Thus, a certain distance between the second fan assembly 120 and the first exhaust hole 103 should be secured in order that the cooking gas discharged from the second fan assembly 120 smoothly flows to the first exhaust hole 103 disposed at the lateral center of the main body 10.

The second fan assembly 120 is disposed in the rear space 10d, and thus the front-rear position of the second fan assembly 120 may be fixed. In consideration of this fact, in the present embodiment, the vertical position of the second fan assembly 120 may be changed to secure a distance between the second fan assembly 120 and the first exhaust hole 103.

That is, as the second fan assembly 120 is disposed at a vertical level as low as possible inside the main body 10, a required distance between the second fan assembly 120 and the first exhaust hole 103 may be secured.

As the second fan assembly 120 is disposed in such a manner, the air discharged from the second fan assembly 120 may smoothly flow to the first exhaust hole 103, and the distance between the second fan assembly 120 and the air intake hole 101 may be shortened.

Accordingly, flow loss inside the cooking appliance may be minimized, and the cooking gas removal performance of the cooking appliance may be more effectively improved.

### Third Embodiment of Blower

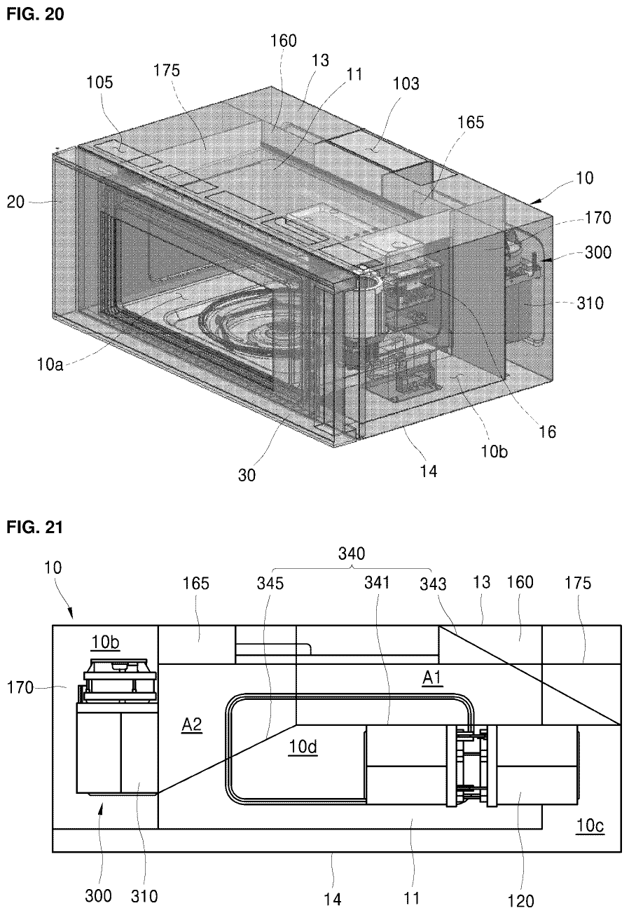

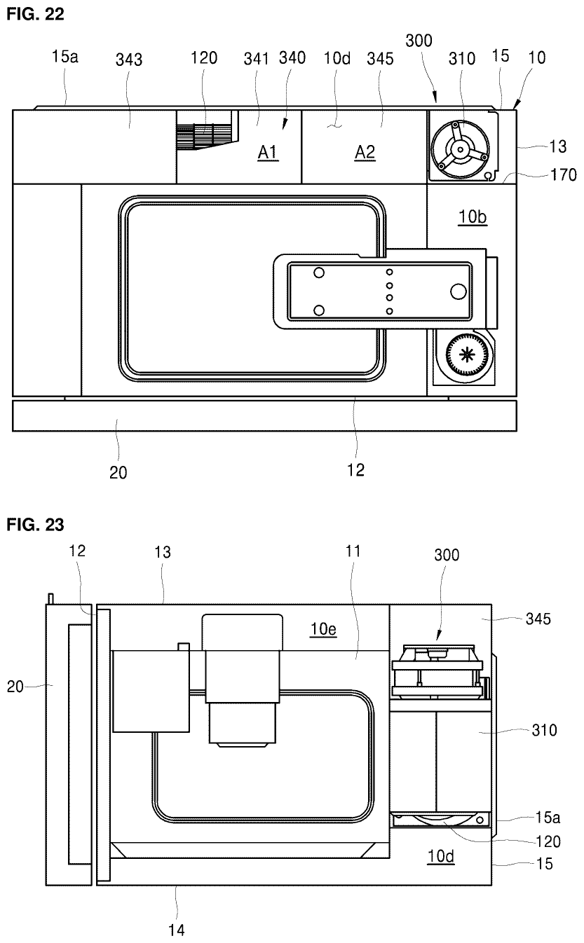

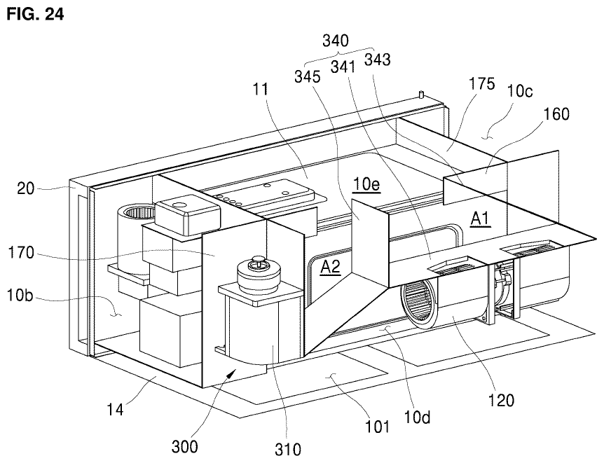

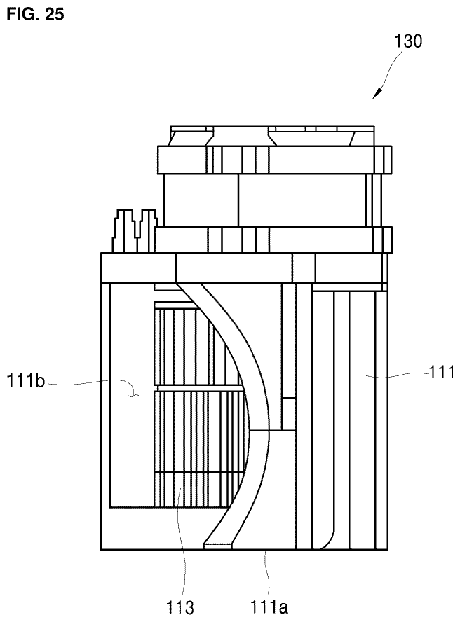

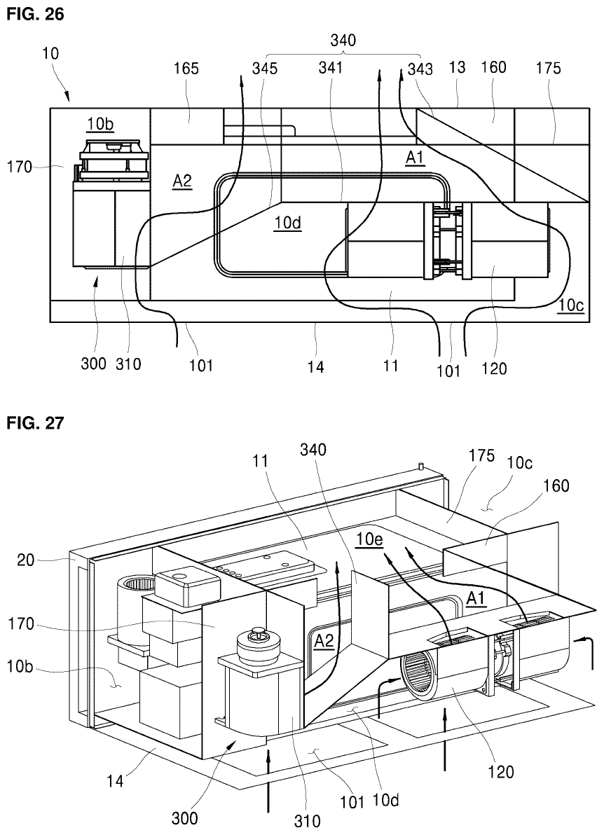

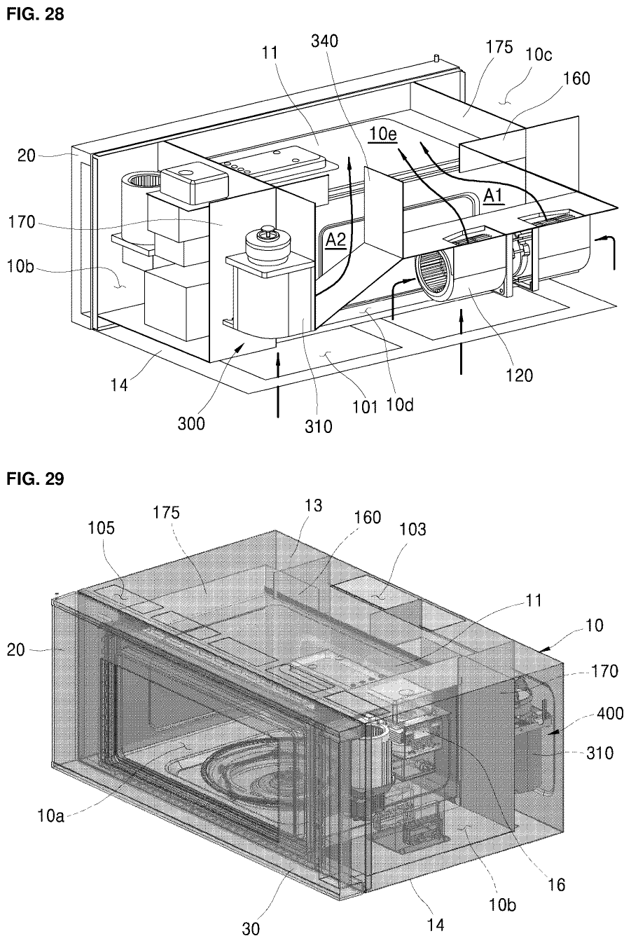

FIG. 20 is a perspective view illustrating an internal structure of a cooking appliance according to a third embodiment of the present disclosure in a see-through state. FIG. 21 is a front view illustrating an internal structure of the cooking appliance illustrated in FIG. 20. FIG. 22 is a plan view showing an internal structure of the cooking appliance shown in FIG. 20. FIG. 23 is a side view illustrating an internal structure of the cooking appliance illustrated in FIG. 20. FIG. 24 is a rear perspective view illustrating an internal structure of the cooking appliance illustrated in FIG. 20. FIG. 25 is a side view illustrating a third fan assembly separated from the cooling appliance illustrated in FIG. 20. FIGS. 26 and 27 are diagrams illustrating a state in which cooking gas is discharged into an outdoor space in the cooking appliance according to the third embodiment of the present disclosure. FIG. 28 is a diagram showing a state in which cooking gas is discharged into an indoor space in the cooking appliance according to the third embodiment of the present disclosure.

Referring to FIGS. 20 to 28, a blower 300 according to the third embodiment of the present disclosure may include the second fan assembly 120 and a third fan assembly 310.

The first fan assembly 110 (see FIG. 6) illustrated in the above-described embodiment may be provided in a structure in which the pair of impellers 113 and the fan housing 111 are respectively disposed on both opposing sides of the fan motor. Hereinafter, the assembly of the impeller 113 and the fan housing 111 will be referred to as a ‘fan module’. Accordingly, each of the second fan assemblies 120 may be provided in a structure in which a pair of fan modules are respectively connected to both opposing sides of the fan motor.

In the blower 300 of the present embodiment, the third fan assembly 310 may be provided in a structure in which one fan module is connected to the fan motor. In an example, the third fan assembly 310 may be provided in a structure in which one fan module is connected to a lower side of the fan motor.

In the third fan assembly 310, the impeller 113 may rotate about the vertical axis. In addition, a suction hole 111a may be disposed in a lower side of the fan housing 111, and a discharge hole 111b may be disposed at a side portion of the fan housing 111.

That is, the third fan assembly 310 may be provided in a form similar to a form in which one half of the first fan assembly 110 is erected in a vertical direction.

The first fan assembly 110 and the third fan assembly 310 may be disposed together in the rear space 10d. In one example, the first fan assembly 110 and the third fan assembly 310 may be laterally arranged and disposed in the rear space 10d.

For example, the third fan assembly 310 may be disposed at one side thereof adjacent to the electronic/electrical component chamber 10b, while the first fan assembly 110 may be disposed at the other side thereof adjacent to the side space 10c opposite thereto.

The main difference between the blower 300 of the present embodiment and the blower 200 (see FIG. 11) illustrated in the second embodiment of the present disclosure is that in the blower 300 of the present embodiment, at least one of the plurality of second fan assemblies 120 is replaced with the third fan assembly 310.

That is, the blower 300 of the present embodiment may include the second fan assembly 120 and the third fan assembly 310 together instead of including only the second fan assemblies 120. For example, the blower 300 of the present embodiment may be configured to include one second fan assembly 120 and one third fan assembly 310.

When one of the plurality of fan assemblies constituting the blower 300 is replaced with the third fan assembly 310 and the third fan assembly 310 replaces the first fan assembly 110 or the second fan assembly 120, a total lateral length of the blower 300 may be reduced.

For example, the lateral length of the blower 300 including one second fan assembly 120 and one third fan assembly 310 may be measured to be smaller than that of the blower 200 including the pair of second fan assemblies 120.

The third fan assembly 310 is configured such that one of the fan modules included in the first fan assembly 110 is erected in the vertical direction. Therefore, the lateral length of the third fan assembly 310 is inevitably very smaller compared to that of each of the first fan assembly 110 and the second fan assembly 120.

Considering this fact, the blower 300 of the present embodiment including the third fan assembly 310 may be provided in a significantly smaller size than that of the blower including only the first fan assembly 110 or the second fan assembly 120.

When the blower 300 of this configuration is applied to the cooking appliance, the size of the cooking appliance, particularly the lateral length of the cooking appliance, may be reduced as the space occupied by the blower 300 is reduced.

In addition, considering that the first fan assembly 110 provides higher performance than that of the second fan assembly 120, it may be expected that the third fan assembly 310 may provide 50% or greater of the performance of the second fan assembly 120.

That is, the blower 300 of the present embodiment may provide a performance level lower than that of a case in which the blower includes a pair of second fan assemblies 120 but superior to that of a case in which the blower includes one second fan assembly 120 or one and half of the second fan assembly 120.

In consideration of this fact, when the size of the cooking appliance is a bit small such the plurality of first fan assemblies 110 and the plurality of second fan assemblies 120 are not received therein, the blower 300 of the present embodiment may be very suitable for being applied to this cooking appliance.

In addition, in the third fan assembly 310, the suction hole 111a may be disposed in the lower side of the fan housing 111. Accordingly, the suction hole 111a may be disposed at the lowermost end of the third fan assembly 310, and may be disposed at a very adjacent position to the air intake hole defined at the lower end of the cooking appliance.

Considering that as a distance between the suction hole 111a and the air intake hole 101 decreases, the suction performance of the fan assembly may be significantly improved based on the same output of the fan motor, it may be identified that the suction performance of the third fan assembly 310 may be significantly improved as the suction hole 111a of the third fan assembly 310 is closer to the air intake hole 101.

That is, although the performance of the third fan assembly 310 may be lower than that of the second fan assembly 120, this performance difference may be substantially compensated for via the performance improvement value obtained due to the reduction of the distance between the suction hole 111a and the air intake hole 101.

Considering this fact, it may be evaluated that the blower 300 of the present embodiment may provide an effect of contributing to miniaturization of the cooking appliance while providing a cooking gas removal performance equal to or higher than that of each of other types of blowers.

The cooking appliance of the present embodiment including the blower 300 as described above may maintain a compact size and provide improved cooking gas removal performance.

In one example, the cooking appliance of the present embodiment may include a flow path defining member 340. The flow path defining member 340 may constitute an exhaust flow path A1 and A2 inside the cooking appliance.

The exhaust flow path A1 and A2 may connect the blower 300 and the upper space 10e to each other, and may guide air flow to the upper space 10e from at least one of the second fan assembly 120 and the third fan assembly 310. The exhaust flow path A1 and A2 may guide the flow of air discharged from the blower 300 toward the exhaust holes 103 and 105.

In the present embodiment, an example is illustrated in which the exhaust flow path A1 and A2 includes the first exhaust flow path A1 and the second exhaust flow path A2. The first exhaust flow path A1 and the second exhaust flow path A2 may be arranged and disposed in the rear space 10d.

An inlet of the first exhaust flow path A1 may be opened toward the second fan assembly 120, and an inlet of the second exhaust flow path A2 may be opened toward the third fan assembly 310. The outlets of the first exhaust flow path A1 and the second exhaust flow path A2 may be opened toward the upper space 10e.

That is, the first exhaust flow path A1 may constitute a flow path for guiding the air flow from the discharge hole 121a of the second fan assembly 120 to the upper space 10e inside the cooking appliance. In addition, the second exhaust flow path A2 may constitute a flow path for guiding the air flow from the discharge hole 111b of the third fan assembly 310 to the upper space 10e inside the cooking appliance.

In one example, the flow path defining member 340 may include a fastening plate 341, a first flow path plate 343, and a second flow path plate 345.

The fastening plate 341 may be installed on the second fan assembly 120. The fastening plate 241 may be coupled to the upper surface of the second fan assembly 120 while opening the discharge hole 121b upwardly.

In one example, the fastening plate 341 may be constructed to cover all of the plurality of second fan assemblies 120 disposed in the rear space 10d while being positioned on top thereof. The fastening plate 341 may have a length corresponding to a total lateral length of the plurality of second fan assemblies 120 disposed in the rear space 10d, and may be coupled to an upper surface of each of the plurality of second fan assemblies 120 disposed in the rear space 10d.

The first flow path plate 343 may constitute a vertical wall extending upwardly from the fastening plate 341. In one example, the first flow path plate 343 may be connected to one side end in the lateral direction of the fastening plate 341.

The first flow path plate 343 may be formed to extend upwardly from the fastening plate 341. In one example, the first flow path plate 343 may constitute an inclined surface extending upwardly so as to be inclined toward the lateral center of the rear space 10d. The first flow path plate 343 may guide the flow of air flowing through the first exhaust flow path A1 to the lateral center of the rear space 10d.

The first flow path plate 343 is constructed to protrude upwardly beyond the upper surface of the cavity 11. In one example, the first flow path plate 343 may protrude to a vertical level such that an upper end of the first flow path plate 343 is in contact with an upper surface of the cabinet 13.

Accordingly, the outlet of the first exhaust flow path A1 may be connected only to the upper space 10e, and the flow of air discharged from the second fan assembly 120 may be guided only to the upper space 10e through the first exhaust flow path A1.

The second flow path plate 345 may be installed on the third fan assembly 310. In one example, the second flow path plate 345 may be formed in an approximately “U” shape.

One side in the lateral direction of the second flow path plate 345 may be coupled to the third fan assembly 310 while opening the discharge hole 111b in the lateral direction. In addition, the other side in the lateral direction of the second flow path plate 345 may be coupled to the other side end in the lateral direction of the fastening plate 341.

One lateral side and the other lateral side of the second flow path plate 345 may respectively define boundary surfaces of both lateral sides of the second exhaust flow path A2, while a bottom surface of the second flow path plate 345 may define a lower boundary surface of the second exhaust flow path A2.

In addition, the other side in the lateral direction of the second flow path plate 345 may define a boundary surface of the other side in the lateral direction of the second exhaust flow path A2, and at the same time, may define a boundary surface of one side in the lateral direction of the first exhaust flow path A1.

The left upper end and the right upper end of the second flow path plate 345 are constructed to protrude upwardly beyond the upper surface of the cavity 11. In one example, each of the upper left end and the upper right end of the second flow path plate 345 may protrude to a vertical level enough to contact the upper surface of the cabinet 13.

Accordingly, the outlet of the second exhaust flow path A2 may be connected only to the upper space 10e, and the flow of air discharged from the third fan assembly 310 may be guided only to the upper space 10e through the second exhaust flow path A2.

### Fourth Embodiment of Blower

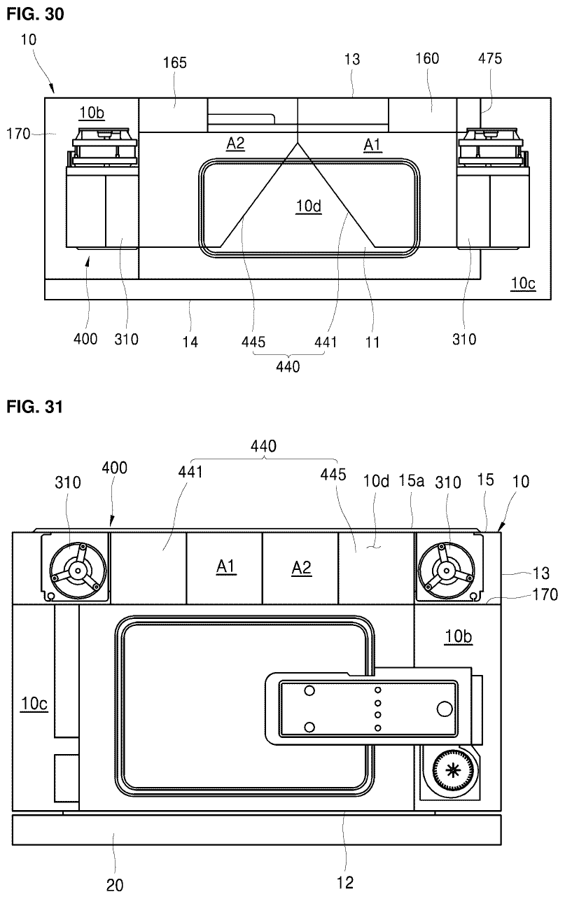

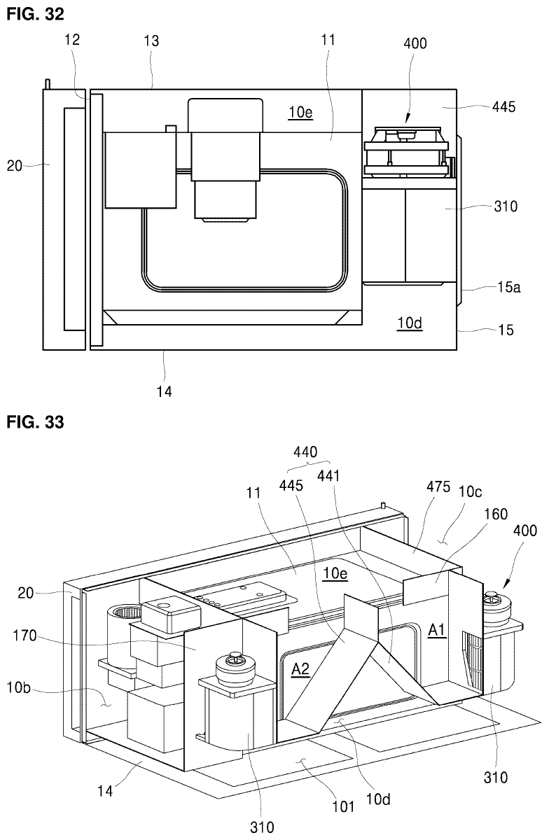

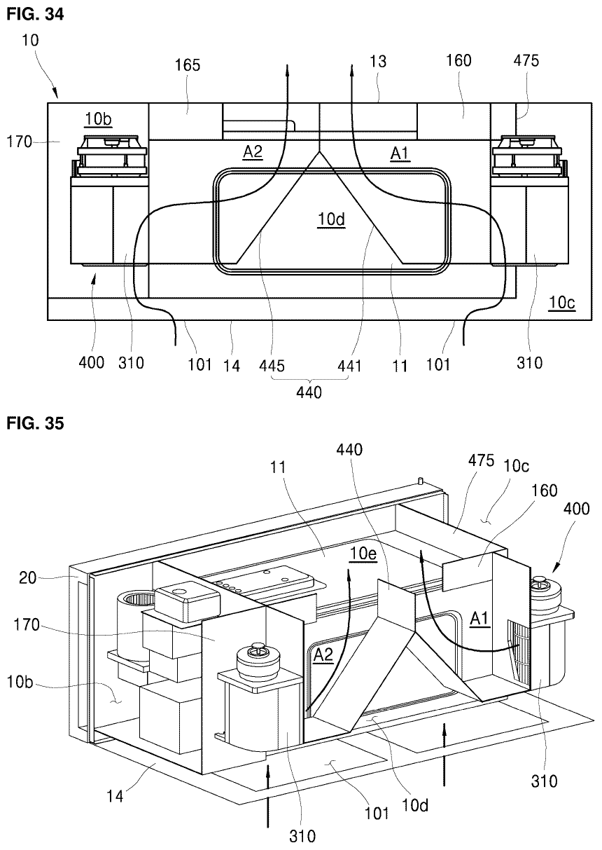

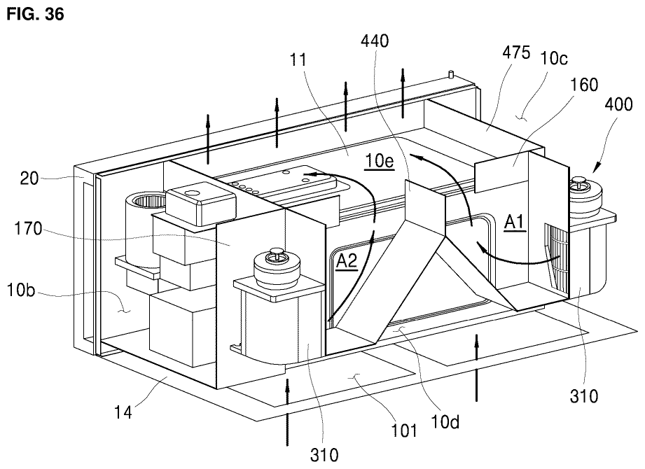

FIG. 29 is a perspective view illustrating an internal structure of a cooking appliance according to a fourth embodiment of the present disclosure in a see-through state. FIG. 30 is a front view illustrating an internal structure of the cooking appliance illustrated in FIG. 29. FIG. 31 is a plan view showing an internal structure of the cooking appliance shown in FIG. 29. FIG. 32 is a side view illustrating an internal structure of the cooking appliance illustrated in FIG. 29. FIG. 33 is a rear perspective view illustrating an internal structure of the cooking appliance illustrated in FIG. 29. FIGS. 34 and 35 are diagrams illustrating a state in which cooking gas is discharged into an outdoor space in the cooking appliance according to the fourth embodiment of the present disclosure. FIG. 36 is a diagram showing a state in which cooking gas is discharged into an indoor space in the cooking appliance according to the fourth embodiment of the present disclosure.

Referring to FIGS. 29 to 36, a blower 400 according to the fourth embodiment of the present disclosure may include a plurality of third fan assemblies 310.

A main difference between the blower 300 (see FIG. 20) illustrated in the above-described embodiment and the blower 400 of the present embodiment is that the blower 400 of the present embodiment includes only the third fan assembles 310 without the first fan assembly or the second fan assembly.

That is, the blower 400 of the present embodiment may include a plurality of third fan assemblies 310 disposed in the rear space 10d.

In one example, a pair of third fan assemblies 310 may be disposed in the rear space 10d so as to be spaced apart from each other by a predetermined distance in the lateral direction. For example, one of the pair of third fan assemblies 310 may be disposed in one side thereof adjacent to the electronic/electrical component chamber 10b, and the other of the pair of third fan assemblies 310 may be disposed in the other side thereof adjacent to the side space 10c opposite thereto.

As described above, the blower 400 including only the third fan assembly 310 may be provided in a significantly smaller size than that of the blower including only the first fan assembly 110 or the second fan assembly 120.

The cooking appliance of the present embodiment including the blower 400 may have a smaller size and provide more improved cooking gas removal performance than those of the cooking appliances including other types of blowers.

In one example, the cooking appliance of the present embodiment may include a flow path defining member 440. Like the flow path defining member 340 (see FIG. 24) illustrated in the above-described embodiment, the flow path defining member 440 may define the first exhaust flow path A1 and the second exhaust flow path A2.

An inlet of the first exhaust flow path A1 may be opened toward the third fan assembly 310 disposed at a side thereof adjacent to the side space 10c, and an inlet of the second exhaust flow path A2 may be opened toward the third fan assembly 310 disposed at a side thereof adjacent to the electronic/electrical component chamber 10b. The outlets of the first exhaust flow path A1 and the second exhaust flow path A2 may be opened toward the upper space 10e.

That is, the first exhaust flow path A1 may constitute a flow path for guiding air flow from the discharge hole 111b of the third fan assembly 310 disposed at a side thereof adjacent to the side space 10c to the upper space 10e inside the cooking appliance. In addition, the second exhaust flow path A2 may constitute a flow path for guiding the flow of air from the discharge hole 111b of the third fan assembly 310 disposed at a side thereof adjacent to the electronic/electrical component chamber 10b to the upper space 10e inside the cooking appliance.

Hereinafter, a side facing the side space 10c around the lateral center of the cooking appliance will be referred to as a right side, and an opposite side thereto, that is, a side facing the electronic/electrical component chamber 10b around the lateral center of the cooking appliance will be referred to as a left side.

In one example, the flow path defining member 440 may include a first flow path plate 441 and a second flow path plate 445.

The first flow path plate 441 may be installed on the third fan assembly 310 (hereinafter, referred to as a “right third fan assembly”) disposed at a side adjacent to the side space 10c, that is, at the right side. In addition, the second flow path plate 445 may be installed on the third fan assembly 310 (hereinafter referred to as a “left third fan assembly”) disposed at a side adjacent to the electronic/electrical component chamber 10b, that is, at the left side.

In one example, each of the first flow path plate 441 and the second flow path plate 445 may be formed in an approximately “U” shape.

The right side of the first flow path plate441 may be coupled to the right third fan assembly 310 while the first flow path plate 441 is constructed to open the discharge hole 111b of the right third fan assembly 310 to the left. In addition, the left side of the second flow path plate 445 may be coupled to the left third fan assembly 310 while the second flow path plate 445 is constructed to open the discharge hole 111b of the left third fan assembly 310 to the right. In addition, the left side of the first flow path plate 441 and the right side of the second flow path plate 445 may be coupled to each other in the respective upper areas thereof.

Left and right sides of the first flow path plate 441 may respectively define boundary surfaces of both lateral sides of the first exhaust flow path A1, and a bottom surface of the first flow path plate 441 may define a lower boundary surface of the first exhaust flow path A1.

In addition, left and right sides of the second flow path plate 445 may respectively boundary surfaces of both lateral sides of the second exhaust flow path A2, and a bottom surface of the second flow path plate 445 may define a lower boundary surface of the second exhaust flow path A2.

Although the present disclosure has been described above with reference to the embodiments illustrated in the drawings, this is merely an example, and it will be understood by those of ordinary skill in the art that various modifications and other equivalent embodiments are possible therefrom. Therefore, the true technical protection scope of the present disclosure should be determined by the following claims.

### REFERENCE NUMERALS

10: Main body
10a: Cooking chamber
10b: Electronic/electrical component chamber
10c: Side space
10d: Rear space
10e: Upper space
11: Cavity
12: Front Plate
13: Cabinet
14: Base plate
15: Rear plate
15a: Rearward protruding surface
20: Door
30: Control panel
40: Convection module
100,200,300: blower
101: Air intake hole
103: First exhaust hole
105: Second exhaust hole
110: First fan assembly
111: Fan housing
111a: Suction hole
111b: Discharge hole
113: Impeller
210: Second fan assembly
211: Fan housing
211a: Suction hole
211b: Discharge hole
213: Impeller
310: Third fan assembly

1. A cooking appliance comprising:
a main body including a cavity having a cooking chamber defined therein; and
a blower disposed inside the main body,
wherein the main body has an air intake hole disposed below the blower, and an exhaust hole disposed above the air intake hole,
wherein the blower includes a fan assembly disposed in a space communicating with the air intake hole and the exhaust hole,
wherein the fan assembly includes:
a fan housing having a suction hole and a discharge hole; and
an impeller accommodated in the fan housing and configured to suction air through the suction hole and discharge the suctioned air through the discharge hole,
wherein the impeller is configured to rotate about a vertical axis and suction the air in a vertical direction.

2. The cooking appliance of claim 1, wherein the fan assembly is disposed in rear of the cavity, and is configured to suction the air through the air intake hole, and discharge the suctioned air to the exhaust hole.

3. The cooking appliance of claim 2, wherein the main body further includes a rear plate disposed in rear of the cavity,
wherein the fan assembly is disposed in a rear space defined between the cavity and the rear plate.

4. The cooking appliance of claim 2, wherein the main body further includes a cabinet having an upper surface disposed above the cavity,
wherein the exhaust hole communicates with an upper space defined between an upper surface of the cavity and the upper surface of the cabinet,
wherein the fan assembly is configured to discharge the suctioned air to the upper space.

5. The cooking appliance of claim 4, wherein the exhaust hole is formed to extend through the upper surface of the cabinet.

6. The cooking appliance of claim 4, wherein the discharge hole is disposed to face a lateral direction, and is disposed to face a center point in a lateral direction of the cooking appliance.

7. The cooking appliance of claim 1, wherein the suction hole is disposed to face toward the air intake hole.

8. The cooking appliance of claim 1, wherein a plurality of fan assemblies are arranged laterally.

9. The cooking appliance of claim 1, wherein the fan assembly includes a pair of fan assemblies arranged symmetrically with each other,
wherein the discharge hole defined in one of the pair of fan assemblies is disposed to face toward the discharge hole defined in the other of the pair of fan assemblies.

10. The cooking appliance of claim 1, wherein the blower further includes a second fan assembly configured to suction air in a lateral direction and to discharge the suctioned air upwardly,
wherein the fan assembly and the second fan assembly are disposed in rear of the cavity and are laterally arranged.

11. The cooking appliance of claim 10, wherein the second fan assembly is disposed at a position closer to the air intake hole than to the exhaust hole in a vertical direction.

12. The cooking appliance of claim 10, wherein at least one of the fan assembly and the second fan assembly is disposed between an upper surface and a lower surface of the cavity in a vertical direction.
